(19) United States
(12) Patent Application Publication
(10) Pub. No.: US 2023/0224930 A1
(43) Pub. Date: Jul. 13, 2023

(54) MULTICAST GRANTS TO USER EQUIPMENT OF DIFFERENT CAPABILITIES USING A SINGLE DOWNLINK CONTROL INFORMATION

(71) Applicant: QUALCOMM INCORPORATED, San Diego, CA (US)

(72) Inventors: Min HUANG, Beijing (CN); Chao WEI, Beijing (CN); Chenxi HAO, Beijing (CN)

(21) Appl. No.: 18/000,899

(22) PCT Filed: Jul. 29, 2020
(86) PCT No.: PCT/CN2020/105468

§ 371 Date: Dec. 6, 2022

(51) Int. Cl. H04W 72/30; H04W 72/232

(52) U.S. Cl. CPC H04W 72/30; H04W 72/232

(57) ABSTRACT

Methods, systems, and devices for wireless communications are described. A base station may transmit a single downlink control information (DCI) to indicate two multicast physical downlink shared channels (PDSCHs) for UEs of different capabilities. With the single DCI, different UEs with different capabilities may each receive separate PDSCHs, but the base station may transmit a single downlink control channel to signal the single DCI. The DCI may contain information for each of the multicast PDSCHs, such as a modulation and coding scheme, a time-domain resource assignment, a frequency-domain resource assignment, an antenna ports configuration, etc. for each multicast PDSCH. Subsequently, each UE may receive corresponding multicast PDSCHs parameters from this DCI based on the UE type or capability and may monitor for and receive a corresponding PDSCH from the base station. Additionally, the base station may transmit an activation message for the UEs to receive the single DCI.

### CROSS REFERENCE

The present application is a 371 national stage filing of International PCT Application No. PCT/CN2020/105468 by HUANG et al. entitled “MULTICAST GRANTS TO USER EQUIPMENT OF DIFFERENT CAPABILITIES USING A SINGLE DOWNLINK CONTROL INFORMATION,” filed Jul. 29, 2020, which is assigned to the assignee hereof, and which is expressly incorporated by reference in its entirety herein.

### FIELD OF TECHNOLOGY

The following relates to wireless communications, including multicast grants to user equipment (UEs) of different capabilities using a single downlink control information (DCI).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some cases, one base station may communicate with multiple UEs simultaneously. Accordingly, the base station may communicate with the multiple UEs via broadcasted transmissions to UEs within a coverage area that include the multiple UEs. Alternatively, the base station may multicast the transmissions specifically to the multiple UEs out of all the UEs within the coverage area. However, multicast transmissions may include complex techniques and integrations of different communications layers (e.g., radio and service layer). Improved techniques are desired for multicast communications between a base station and multiple UEs.

### SUMMARY

The described techniques relate to improved methods, systems, devices, and apparatuses that support multicast grants to user equipment (UEs) of different capabilities using a single downlink control information (DCI). Generally, the described techniques provide for a base station to transmit a single DCI to indicate different multicast downlink shared channels configured for different types of UEs with different capabilities, such that upon a UE identifying its type, the UE may then determine corresponding parameters for a multicast downlink shared channel configured for its type from the single DCI. Subsequently, the UE may then monitor for and receive the multicast downlink shared channel from the base station based on the determined parameters from the single DCI. In some implementations, the base station may transmit an activation message to the UE (e.g., and additional UEs configured for multicast communications with the base station) to indicate that the UE is to receive the single DCI carrying parameters for the different multicast downlink shared channels. The different types of UEs may include different capabilities, different numbers of antennas, different communication bandwidths, different battery capacities, different processing capabilities, or a combination thereof. For example, one type of UE may be a New Radio (NR)-Reduced Capability (RedCap) UE (e.g., NR-Light UE) that has lower capabilities, a lower number of antennas, a smaller communication bandwidth, a shorter battery capacity, lesser processing capabilities, or a combination thereof than another type of UE configured for NR communications (e.g., an NR regular UE).

In some implementations, the single DCI may include an indication of a time-domain resource allocation for the different multicast downlink shared channels, where the time-domain resource allocation is divided into multiple parts. Subsequently, a multicast downlink shared channel configured for a type of UE with the lower capabilities may occur during each part of the multiple parts in the time-domain resource allocation, and a different multicast downlink shared channel configured for a type of UE with higher capabilities may occur during a first part of the multiple parts in the time-domain resource allocation. In some implementations, each part of the multiple parts may include a repetition of a same multicast downlink shared channel or may include different redundant versions (RVs) of the same multicast downlink shared channel. Additionally, the multiple parts may be located within a same scheduling time-domain unit (e.g., a slot, a mini-slot, etc.), or each part of the multiple parts may be located in a separate scheduling time-domain unit.

A method of wireless communications at a UE is described. The method may include receiving, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE, identifying that the UE is of the first type of UE, determining, from the DCI message, a set of multicast downlink shared channel parameters for receiving the first multicast downlink shared channel based on the UE being of the first type of UE, and monitoring for the first multicast downlink shared channel based on the set of multicast downlink shared channel parameters.

An apparatus for wireless communications at a UE is described. The apparatus may include a processor, memory coupled with the processor, and instructions stored in the memory. The instructions may be executable by the processor to cause the apparatus to receive, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE, identify that the UE is of the first type of UE, determine, from the DCI message, a set of multicast downlink shared channel parameters for receiving the first multicast downlink shared channel based on the UE being of the first type of UE, and monitor for the first multicast downlink shared channel based on the set of multicast downlink shared channel parameters.

Another apparatus for wireless communications at a UE is described. The apparatus may include means for receiving, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE, identifying that the UE is of the first type of UE, determining, from the DCI message, a set of multicast downlink shared channel parameters for receiving the first multicast downlink shared channel based on the UE being of the first type of UE, and monitoring for the first multicast downlink shared channel based on the set of multicast downlink shared channel parameters.

A non-transitory computer-readable medium storing code for wireless communications at a UE is described. The code may include instructions executable by a processor to receive, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE, identify that the UE is of the first type of UE, determine, from the DCI message, a set of multicast downlink shared channel parameters for receiving the first multicast downlink shared channel based on the UE being of the first type of UE, and monitor for the first multicast downlink shared channel based on the set of multicast downlink shared channel parameters.

Some examples of the method, apparatuses, and non-transitory computer-readable medium described herein may further include operations, features, means, or instructions for receiving, from the base station and in advance of receipt of the DCI message, an activation message indicating that DCI messages received from the base station would include the indication.

In some examples of the method, apparatuses, and non-transitory computer-readable medium described herein, receiving the activation message may include operations, features, means, or instructions for receiving, from the base station, the activation message via radio resource control (RRC) signaling or a medium access control (MAC) control element (CE) or DCI.

In some examples of the method, apparatuses, and non-transitory computer-readable medium described herein, receiving the activation message may include operations, features, means, or instructions for receiving, from the base station, the activation message via DCI which may be scrambled with a single cell radio network temporary identifier (SC-RNTI) specific to the base station.

In some examples of the method, apparatuses, and non-transitory computer-readable medium described herein, receiving the DCI message including the indication may include operations, features, means, or instructions for receiving individual sets of multicast downlink shared channel parameters for the first multicast downlink shared channel and the second multicast downlink shared channel.

In some examples of the method, apparatuses, and non-transitory computer-readable medium described herein, the individual sets of multicast downlink shared channel parameters include a modulation and coding scheme (MCS), a time-domain resource assignment (TDRA), a frequency-domain resource assignment (FDRA), an antenna ports configuration, or a combination thereof for each of the first multicast downlink shared channel and the second multicast downlink shared channel.

In some examples of the method, apparatuses, and non-transitory computer-readable medium described herein, one or more parameters of the individual sets of multicast downlink shared channel parameters may be the same for the first multicast downlink shared channel and the second multicast downlink shared channel.

Some examples of the method, apparatuses, and non-transitory computer-readable medium described herein may further include operations, features, means, or instructions for determining a time-domain resource allocation for at least one of the first multicast downlink shared channel and the second multicast downlink shared channel based on the DCI message, where the time-domain resource allocation may be divided into a set of parts.

In some examples of the method, apparatuses, and non-transitory computer-readable medium described herein, monitoring for the first multicast downlink shared channel may include operations, features, means, or instructions for monitoring for the first multicast downlink shared channel in a first part of the set of parts based on the UE being of the first type, where the first type of UE may have at least one of the following: more capabilities than the second type of UE, more antennas than the second type of UE, larger or more communication bandwidths than the second type of UE, greater battery capacity than the second type of UE, or greater processing capabilities than the second type of UE.

In some examples of the method, apparatuses, and non-transitory computer-readable medium described herein, monitoring for the first multicast downlink shared channel may include operations, features, means, or instructions for monitoring for the first multicast downlink shared channel across all parts of the set of parts based on the UE being of the first type, where the first type of UE may have at least one of the following: fewer capabilities than the second type of UE, fewer antennas than the second type of UE, smaller or fewer communication bandwidths than the second type of UE, lesser battery capacity than the second type of UE, or lesser processing capabilities than the second type of UE.

Some examples of the method, apparatuses, and non-transitory computer-readable medium described herein may further include operations, features, means, or instructions for receiving, from the base station, a TDRA and an FDRA based on the UE being of the first type of UE, a number of the set of parts, an additional indication of using repetitions or different RVs for the first multicast downlink shared channel in each part of the set of parts, an RV mapping order, or a combination thereof.

In some examples of the method, apparatuses, and non-transitory computer-readable medium described herein, each part of the set of parts may include a repetition of the second multicast downlink shared channel.

In some examples of the method, apparatuses, and non-transitory computer-readable medium described herein, each part of the set of parts may include a different RV of the second multicast downlink shared channel.

In some examples of the method, apparatuses, and non-transitory computer-readable medium described herein, the set of parts may be located within a single scheduling time-domain unit, or each part may be located in a separate scheduling time-domain unit.

In some examples of the method, apparatuses, and non-transitory computer-readable medium described herein, a scheduling time-domain unit may include a slot, a mini-slot, or a combination thereof.

In some examples of the method, apparatuses, and non-transitory computer-readable medium described herein, the first type of UE and the second type of UE may have different capabilities, different numbers of antennas, different communication bandwidths, different battery capacities, different processing capabilities, or a combination thereof.

A method of wireless communications at a base station is described. The method may include identifying that a set of UEs in communication with a cell of the base station include at least two different types of UEs, including at least a first type of UE and a second type of UE, transmitting, to the set of UEs, a DCI message including an indication of a first multicast downlink shared channel being configured for the first type of UE and a second multicast downlink shared channel being configured for the second type of UE, and transmitting, to the set of UEs, both the first multicast downlink shared channel and the second multicast downlink shared channel in accordance with corresponding multicast downlink shared channel parameters included in the DCI message.

An apparatus for wireless communications at a base station is described. The apparatus may include a processor, memory coupled with the processor, and instructions stored in the memory. The instructions may be executable by the processor to cause the apparatus to identify that a set of UEs in communication with a cell of the base station include at least two different types of UEs, including at least a first type of UE and a second type of UE, transmit, to the set of UEs, a DCI message including an indication of a first multicast downlink shared channel being configured for the first type of UE and a second multicast downlink shared channel being configured for the second type of UE, and transmit, to the set of UEs, both the first multicast downlink shared channel and the second multicast downlink shared channel in accordance with corresponding multicast downlink shared channel parameters included in the DCI message.

Another apparatus for wireless communications at a base station is described. The apparatus may include means for identifying that a set of UEs in communication with a cell of the base station include at least two different types of UEs, including at least a first type of UE and a second type of UE, transmitting, to the set of UEs, a DCI message including an indication of a first multicast downlink shared channel being configured for the first type of UE and a second multicast downlink shared channel being configured for the second type of UE, and transmitting, to the set of UEs, both the first multicast downlink shared channel and the second multicast downlink shared channel in accordance with corresponding multicast downlink shared channel parameters included in the DCI message.

A non-transitory computer-readable medium storing code for wireless communications at a base station is described. The code may include instructions executable by a processor to identify that a set of UEs in communication with a cell of the base station include at least two different types of UEs, including at least a first type of UE and a second type of UE, transmit, to the set of UEs, a DCI message including an indication of a first multicast downlink shared channel being configured for the first type of UE and a second multicast downlink shared channel being configured for the second type of UE, and transmit, to the set of UEs, both the first multicast downlink shared channel and the second multicast downlink shared channel in accordance with corresponding multicast downlink shared channel parameters included in the DCI message.

Some examples of the method, apparatuses, and non-transitory computer-readable medium described herein may further include operations, features, means, or instructions for transmitting, to the set of UEs and in advance of transmission of the DCI message, an activation message indicating that DCI messages transmitted from the base station would include the indication.

In some examples of the method, apparatuses, and non-transitory computer-readable medium described herein, transmitting the activation message may include operations, features, means, or instructions for transmitting, to the set of UEs, the activation message via RRC signaling or a MAC CE or DCI.

In some examples of the method, apparatuses, and non-transitory computer-readable medium described herein, transmitting the activation message may include operations, features, means, or instructions for transmitting, to the set of UEs, the activation message via DCI which may be scrambled with an SC-RNTI specific to the base station.

Some examples of the method, apparatuses, and non-transitory computer-readable medium described herein may further include operations, features, means, or instructions for determining to transmit the activation message for the DCI message based on a load status of a downlink control channel for the set of UEs.

In some examples of the method, apparatuses, and non-transitory computer-readable medium described herein, transmitting the DCI message including the indication may include operations, features, means, or instructions for transmitting individual sets of multicast downlink shared channel parameters for each of the first multicast downlink shared channel and the second multicast downlink shared channel.

In some examples of the method, apparatuses, and non-transitory computer-readable medium described herein, the individual sets of multicast downlink shared channel parameters include a modulation and coding scheme, a TDRA, an FDRA, an antenna ports configuration, or a combination thereof for each of the first multicast downlink shared channel and the second multicast downlink shared channel.

In some examples of the method, apparatuses, and non-transitory computer-readable medium described herein, one or more parameters of the individual sets of multicast downlink shared channel parameters may be the same or may be related values for each of the first multicast downlink shared channel and the second multicast downlink shared channel.

In some examples of the method, apparatuses, and non-transitory computer-readable medium described herein, transmitting the first multicast downlink shared channel and the second multicast downlink shared channel may include operations, features, means, or instructions for transmitting, to the set of UEs, the first multicast downlink shared channel and the second multicast downlink shared channel in a time-domain resource allocation, where the time-domain resource allocation may be divided into a set of parts.

Some examples of the method, apparatuses, and non-transitory computer-readable medium described herein may further include operations, features, means, or instructions for transmitting the first multicast downlink shared channel in a first part of the set of parts, where the first multicast downlink shared channel may be transmitted for the first type of UE, and transmitting the second multicast downlink shared channel across all parts of the set of parts, where the second downlink shared channel may be transmitted for the second type of UE, where the first type of UE may have at least one of the following: more capabilities than the second type of UE, more antennas than the second type of UE, larger or more communication bandwidths than the second type of UE, greater battery capacity than the second type of UE, or greater processing capabilities than the second type of UE.

In some examples of the method, apparatuses, and non-transitory computer-readable medium described herein, each part of the set of parts may include a repetition of the second multicast downlink shared channel.

In some examples of the method, apparatuses, and non-transitory computer-readable medium described herein, each part of the set of parts may include a different RV of the second multicast downlink shared channel.

Some examples of the method, apparatuses, and non-transitory computer-readable medium described herein may further include operations, features, means, or instructions for transmitting, to the set of UEs, a TDRA and an FDRA for the first multicast downlink shared channel and the second multicast downlink shared channel based on a type of UE, a number of the set of parts, an additional indication of using repetitions or different RVs for the multicast downlink shared channel in each part of the set of parts, an RV mapping order, or a combination thereof.

In some examples of the method, apparatuses, and non-transitory computer-readable medium described herein, the set of parts may be located within a single scheduling time-domain unit, or each part may be located in a separate scheduling time-domain unit.

In some examples of the method, apparatuses, and non-transitory computer-readable medium described herein, a scheduling time-domain unit may include a slot, a mini-slot, or a combination thereof.

In some examples of the method, apparatuses, and non-transitory computer-readable medium described herein, the first type of UE and the second type of UE may have different capabilities, different numbers of antennas, different communication bandwidths, different battery capacities, different processing capabilities, or a combination thereof.

### BRIEF DESCRIPTION OF THE DRAWINGS

FIG. 1 illustrates an example of a system for wireless communications that supports multicast grants to user equipment (UEs) of different capabilities using a single downlink control information (DCI) in accordance with aspects of the present disclosure.

FIG. 2 illustrates an example of a wireless communications system that supports multicast grants to UEs of different capabilities using a single DCI in accordance with aspects of the present disclosure.

FIG. 3 illustrates an example of a multicast downlink shared channel configuration that supports multicast grants to UEs of different capabilities using a single DCI in accordance with aspects of the present disclosure.

FIGS. 4A, 4B, 5A, and 5B illustrate examples of time-domain resource allocations that support multicast grants to UEs of different capabilities using a single DCI in accordance with aspects of the present disclosure.

FIG. 6 illustrates an example of a multicast configuration that supports multicast grants to UEs of different capabilities using a single DCI in accordance with aspects of the present disclosure.

FIG. 7 illustrates an example of a process flow that supports multicast grants to UEs of different capabilities using a single DCI in accordance with aspects of the present disclosure.

FIGS. 8 and 9 show block diagrams of devices that support multicast grants to UEs of different capabilities using a single DCI in accordance with aspects of the present disclosure.

FIG. 10 shows a block diagram of a communications manager that supports multicast grants to UEs of different capabilities using a single DCI in accordance with aspects of the present disclosure.

FIG. 11 shows a diagram of a system including a device that supports multicast grants to UEs of different capabilities using a single DCI in accordance with aspects of the present disclosure.

FIGS. 12 and 13 show block diagrams of devices that support multicast grants to UEs of different capabilities using a single DCI in accordance with aspects of the present disclosure.

FIG. 14 shows a block diagram of a communications manager that supports multicast grants to UEs of different capabilities using a single DCI in accordance with aspects of the present disclosure.

FIG. 15 shows a diagram of a system including a device that supports multicast grants to UEs of different capabilities using a single DCI in accordance with aspects of the present disclosure.

FIGS. 16 through 22 show flowcharts illustrating methods that support multicast grants to UEs of different capabilities using a single DCI in accordance with aspects of the present disclosure.

### DETAILED DESCRIPTION

In some wireless communications systems, communications for New Radio (NR)-Reduced Capability (RedCap) devices may be defined. The NR-RedCap (e.g., NR-Light, NR-Lite) devices may include wearable user equipment (UEs) (e.g., smart wearable devices), industrial wireless sensor networks (IWSNs), video surveillance devices (e.g., surveillance cameras), low-end smartphones, relaxed-Internet of Things (IoT) devices, etc. Additionally, for NR-RedCap communications, enhanced coverage recovery, relaxed timelines (e.g., 10-30 millisecond (ms) latency), and reduced UE bandwidths (e.g., 1-2 megahertz (MHz)) may be defined that are different than other communications systems for NR (e.g., NR-RedCap has different requirements than ultra-reliable low latency communications (URLLC), enhanced mobile broadband (eMBB) communications, enhanced machine type communications (eMTC), Long Term Evolution (LTE), etc.). For example, the NR-RedCap UEs may have lower costs and reduced capabilities, such as a reduced number of antennas, a reduced transmit/receive bandwidth, a limited battery capacity, reduced processing capability of physical downlink control channel (PDCCH) blind decoding, etc., that result in the different requirements.

In some cases, a base station may communicate with multiple UEs at once (e.g., simultaneously) via multicast transmissions that use common downlink channels to reduce signaling overhead for configuring individual downlink channels for each UE. However, when NR-RedCap UEs are part of these multiple UEs, the base station may reduce the modulation and coding scheme (MCS) used, along with other transmission parameters, so as to allow the NR-RedCap UEs to best receive the multicast transmissions. This reduction in MCS, while helpful for the NR-RedCap UEs, may be inefficient for non-NR-RedCap UEs (e.g., regular UEs, standard UEs, higher capability UEs, etc.). Alternatively, the base may transmit two separate PDCCHs in order to schedule two different common physical downlink shared channels (PDSCHs)—one for the NR-RedCap UEs and one for the other UEs. Transmitting two separate PDCCHs may increase the PDCCH resource usage, resulting in increased signaling overhead and inefficient resource usage.

The techniques described herein may enable a base station to transmit a single group common (GC) downlink control information (DCI) to indicate two multicast PDSCHs for non-NR-RedCap UEs (e.g., regular UEs) and NR-RedCap UEs, respectively. In this way, NR-RedCap UEs and other UEs each receive separate PDSCHs, but one PDCCH is transmitted by the base station for the single GC-DCI. The GC-DCI may contain information for each of the multicast PDSCHs, such as an MCS, a time-domain resource assignment (TDRA), a frequency-domain resource assignment (FDRA), an antenna ports configuration, etc. for each multicast PDSCH. Subsequently, each UE may receive corresponding multicast PDSCHs parameters from this GC-DCI based on the UE type/capability and may monitor for and receive a corresponding PDSCH. Additionally, the base station may transmit an activation message to indicate to the UEs that a single GC-DCI is used to schedule both PDSCHs for the different types of UEs.

In some implementations, to reduce or limit a size of the GC-DCI, some of the multicast PDSCH parameters (e.g., fields) may have same or related values. Additionally, a time-domain resource allocation of the multicast PDSCH for the NR-RedCap UEs may be divided into N parts (e.g., N>1), where a first part of the N parts is used as the multicast PDSCH for the non-NR-RedCap UEs. In some implementations, the N parts may be within one slot or may be distributed across multiple slots. Additionally, each part of the N parts may include repetitions of the same multicast PDSCH or may include different redundant versions of the multicast PDSCH.

Aspects of the disclosure are initially described in the context of wireless communications systems. Additionally, aspects of the disclosure are illustrated through an additional wireless communications system, a multicast downlink shared channel configuration, time-domain resource allocation examples, a multicast configuration, and a process flow. Aspects of the disclosure are further illustrated by and described with reference to apparatus diagrams, system diagrams, and flowcharts that relate to multicast grants to UEs of different capabilities using a single DCI.

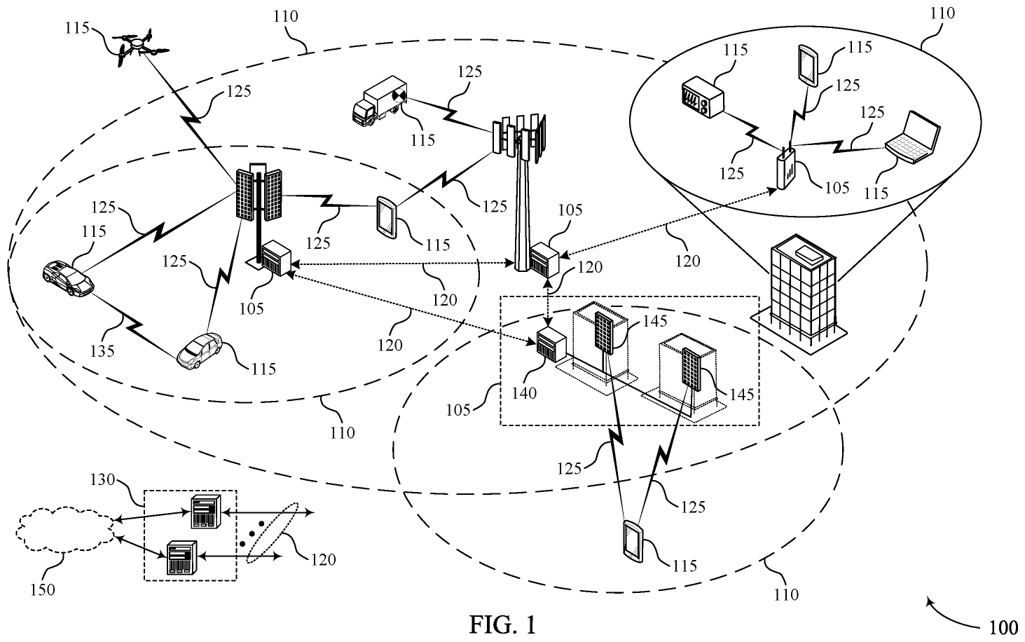

FIG. 1 illustrates an example of a wireless communications system 100 that supports multicast grants to UEs of different capabilities using a single DCI in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)). In some implementations, the TTIs and the sTTIs may be referred to as scheduling time-domain units.

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, different regulations and requirements may be specified for different types of UEs 115 (e.g., premium smartphones for eMBB communications, other vertical type UEs 115 for URLLC and/or V2X, etc.). However, there may exist a strong need for NR to be scalable and deployable in a more efficient and cost-effective way. For example, peak throughput, latency requirements, reliability requirements, etc. may be relaxed, and efficiency (e.g., power consumption, system overhead, etc.) and cost improvements may be desired. Accordingly, a different type of communications may be defined for other UEs 115 that were not covered before. These other UEs 115 may use NR-RedCap communications (e.g., a UE capability/category, such as NR-Light communications, NR-Lite communications, etc.) and may be referred to as NR-RedCap UEs 115 (e.g., NR-Light UEs) that have lower cost, reduced capabilities, reduced number of antennas, reduced communication bandwidths, limited battery capacities, reduced processing capability (e.g., of PDCCH blind decoding), higher coverage recovery, relaxed timelines (e.g., 5-10 ms latency), etc. For example, the NR-RedCap UEs 115 may include wearables (e.g., smart watches), IWSN, surveillance cameras, low-end smartphones, etc.

In some wireless communications systems, a base station 105 may utilize services to provide broadcast communications and/or multicast communications to multiple UEs 115 (e.g., Multimedia Broadcast Multicast Service (MBMS)). The broadcast communications may include transmitting a same message to any UE 115 (including the multiple UEs 115) within a coverage area 110 of the base station 105. Alternatively, the multicast communications may enable a mixed mode of multicast and unicast transmissions specifically to the multiple UEs 115, where the base station 105 may transmit a same message to each of the multiple UEs 115 via a shared radio bearer and/or the same message to each of the multiple UEs 115 via separate radio bearers.

In some cases, different services (e.g., enhanced MBMS (eMBMS)) within the wireless communications systems may provide different mechanisms for communicating between one or more base stations 105 and one or more UEs 115. For example, eMBMS may include a radio-centric multicast mechanism and/or a standalone cellular-based broadcasting mechanism. The radio-centric multicast mechanism may provide a delivery of data over an associated radio interface by enabling a mixed mode of multicast and unicast transmissions. Additionally, the radio-centric multicast mechanism may not necessitate the usage of a broadcast multicast service center (BMSC)-based system architecture, nor the usage of any specific service layer. In some cases, the radio-centric multicast mechanism may be utilized by unicast operators that may further utilize multicast transmissions. Alternatively, the standalone cellular-based broadcasting mechanism may support broadcasted transmissions. Additionally, the standalone cellular-based broadcasting mechanism may or may not necessitate the usage of a specific broadcasting-based or BMSC-based system architecture and may utilize a specific service layer to enhance broadcast communications. Accordingly, operators focused on broadcast communications may utilize the standalone cellular-based broadcasting mechanism.

Additionally, the different services (e.g., eMBMS) that provide the multicast mechanism may rely on a tight integration of multiple communication layers (e.g., radio and service layers). The tight integration of multicast transmissions over the multiple communication layers may be enabled through a common identifier (e.g., a temporary mobile group identity (TGMI)) to link the different communication layers. The common identifier, though, may imply the need to deploy additional centralized architectural entities (e.g., BMSC) to manage the integration of the multiple communication layers and the related common identifiers. Additionally, one or more of the multiple communication layers (e.g., the service layer) may not be needed for one or more different use cases. For example, multiple UEs 115 may receive multicast data from one base station 105, such that a common address for the base station 105 (e.g., a same multicast Internet Protocol (IP) address) is utilized. This common address may have been provided to the multiple UEs 115 as part of an application utilizing the received multicast data or may have been provided to the multiple UEs 115 by other means than the one or more of the multiple communications layers not needed for the use case.

Multicast data of a certain multicast session may be received by a number of UEs 115 who subscribed to this multicast session in a cell of a base station 105. These UEs 115 may include both non-NR-RedCap UEs 115 (e.g., NR regular UEs, NR standard UEs, etc.) and NR-RedCap UEs 115. Due to a lower number of receive antennas and a lower processing capability (e.g., with less receive antennas, less processing hardware, simpler algorithms of channel estimation, MIMO detection, channel code decoding, etc.), given a same MCS, NR-RedCap UEs 115 may have lower receive performance than non-NR-RedCap UEs 115 located in a same or similar position with relation to the cell and the base station 105. Accordingly, to support a same coverage for the NR-RedCap UEs 115 and the non-NR-RedCap UEs 115, the base station 105 may schedule a lower transport format for downlink transmissions (e.g., PDCCHs, PDSCHs, etc.) the NR-RedCap UEs 115 with regards to a transport format that could be scheduled for the non-NR-RedCap UEs 115. The lower transport format for the NR-RedCap UEs 115 may include lower MCS, lower modulation level, lower coding rate, less spatial layers, lower spectrum efficiency in PDSCH and higher aggregation level in PDCCH, etc. Thus, the NR-RedCap UEs 115 may need more radio resources (e.g., time-frequency resource, bandwidth, number of symbols, number of slots, etc.) than non-NR-RedCap UEs 115 to complete transfer of a certain data packet transmitted to both types of UEs 115 in a multicast environment.

To improve a spectrum efficiency of the cell, the base station 105 may schedule a single multicast PDSCH to transfer a common data packet to both non-NR-RedCap UEs 115 and NR-RedCap UEs 115, where the PDSCH is granted by a single PDCCH which is blindly decoded by both the non-NR-RedCap UEs 115 and the NR-RedCap UEs 115. As described previously, the base station 105 may use low transport formats for multicasts of the PDSCHs and PDCCHs for both the non-NR-RedCap UEs 115 and the NR-RedCap UEs 115 due to the low receive performance of the NR-RedCap UEs 115. However, the non-NR-RedCap UEs 115 may have a higher receive capability (e.g., more receive antennas, more processing hardware, more complicated algorithms, etc.) and, thus, may feel unsatisfied to receive these common PDCCHs and PDSCHs using the low transport formats because receiving such common PDSCHs may cause lower throughput, longer latency, and higher power consumption for the non-NR-RedCap UEs 115.

For example, a multicast PDSCH using the low transport formats may span a large number of scheduled time-domain units (e.g., symbols, slots, RBs, etc.) for the sake of the NR-RedCap UEs 115, resulting in unnecessary resource consumption and higher signal processing (e.g., and higher power consumption as a result) at the non-NR-RedCap UEs 115. To receive this multicast PDSCH with the low transport format, the base station 105 may not schedule unicast transfer of other data for the non-NR-RedCap UEs 115 in the scheduled time-domain units of the multicast PDSCH (e.g., if multiple PDSCHs are not supported) or may not schedule other types of data transfer in the time-frequency resources of the multicast PDSCH (e.g., if multiple PDSCHs are supported). By not scheduling transfer of other data for the non-NR-RedCap UEs 115, overall data transfer throughput may be reduced for the non-NR-RedCap UEs 115, and data transfer latency for the non-NR-RedCap UEs 115 may be increased.

Additionally or alternatively, a multicast PDCCH using the low transport formats may use a large number of control channel elements (CCEs) for the sake of the NR-RedCap UEs 115. Subsequently, to receive this PDCCH, the non-NR-RedCap UEs 115 may consume a large portion of non-overlapping CCEs budget in PDCCH processing capability. By consuming the large portion of non-overlapping CCEs budget, the non-NR-RedCap UEs 115 may have less PDCCH processing capability for other PDSCH grants in a same slot. In some cases, another unicast transfer may be scheduled for the non-NR-RedCap UEs 115 by a less-CCE PDCCH (e.g., a PDCCH with a lesser number of CCEs), but the less-CCE PDCCH may result in an increased PDCCH decoding error risk based on the lesser number of CCEs. Additionally or alternatively, using the low transport formats for the multicast PDCCHs and PDSCHs may increase a number of resources (e.g., radio resources) to transmit the multicast PDCCHs and PDSCHs (e.g., high-radio-resource-consumed PDCCH/PDSCH), which may cost a higher amount of power consumption at the non-NR-RedCap UEs 115, thus reducing battery lifetime (e.g., battery lasting time) for the non-NR-RedCap UEs 115.

In some cases, the base station 105 may respectively transmit two multicast PDSCHs to non-NR-RedCap UEs 115 and to NR-RedCap UEs 115 to transfer a same multicast data packet to both types of UEs 115, where the two multicast PDSCHs are granted by two group-common DCIs respectively transmitted to the non-NR-RedCap UEs 115 and to the NR-RedCap UEs 115. Due to a higher receive capability, a PDSCH for the non-NR-RedCap UEs 115 may occupy less radio resources (e.g., fewer time-frequency resources), such as less OFDM symbols or less frequency RBs than those needed for the NR-RedCap UEs 115. These two PDSCHs may be either non-overlapping or partial overlapping. With partial overlapping PDSCHs, the base station 105 may use less PDSCH radio resources than non-overlapping PDSCHs.

To make the UEs 115 distinguish different DCIs (e.g., GC-DCIs) scheduling corresponding PDSCHs, the base station 105 may transmit the different DCIs in two different search spaces or may scramble the different DCIs with two different group radio network temporary identifier (G-RNTI) values for the base station 105. Accordingly, the different DCIs may help increase throughput for the non-NR-RedCap UEs 115 and reduce power consumption at the non-NR-RedCap UEs 115. However, if two DCIs are used to grant the two PDSCHs, the PDCCH resource usage may be doubled with regards to transmitting a single DCI indicating one multicast PDSCH for all UEs 115. This increase in PDCCH resource usage may become more severe when there are multiple multicast sessions in a cell. Each multicast session may use a dedicated DCI to grant a corresponding PDSCH. If the on-durations of these multiple multicast sessions occur in a same slot, the increase in PDCCH resource usage for all DCIs of a multicast transfer may result in PDCCH resource exhaustion. Techniques are desired for enabling multicast transmissions to different UEs 115 with different capabilities (e.g., NR-RedCap UEs 115 and non-NR-RedCap UEs 115).

Wireless communications system 100 may support efficient techniques for reducing PDCCH resource usage for multicast data transfer with a co-existence of non-NR-RedCap UEs 115 and NR-RedCap UEs 115. For example, a base station 105 may send an indication to all UEs 115 (e.g., both non-NR-RedCap UEs 115 and NR-RedCap UEs 115) in a cell to activate a single DCI indicating two PDSCHs for the non-NR-RedCap UEs 115 and the NR-RedCap UEs 115 (e.g., a first multicast PDSCH configured for the non-NR-RedCap UEs 115 and a second multicast PDSCH configured for the NR-RedCap UEs 115. Subsequently, the base station 105 may then transmit this single DCI that includes parameters for the two PDSCHs. For example, the single DCI may contain information for each of the PDSCHs, such as an MCS, a time-domain resource assignment (TDRA), a frequency-domain resource assignment (FDRA), an antenna ports configuration, etc. for each multicast PDSCH. Accordingly, a UE 115 may then receive the DCI and determine corresponding multicast PDSCH parameters from the DCI based on its type or capability, and the UE may monitor for and receive a corresponding PDSCH based on the multicast PDSCH parameters.

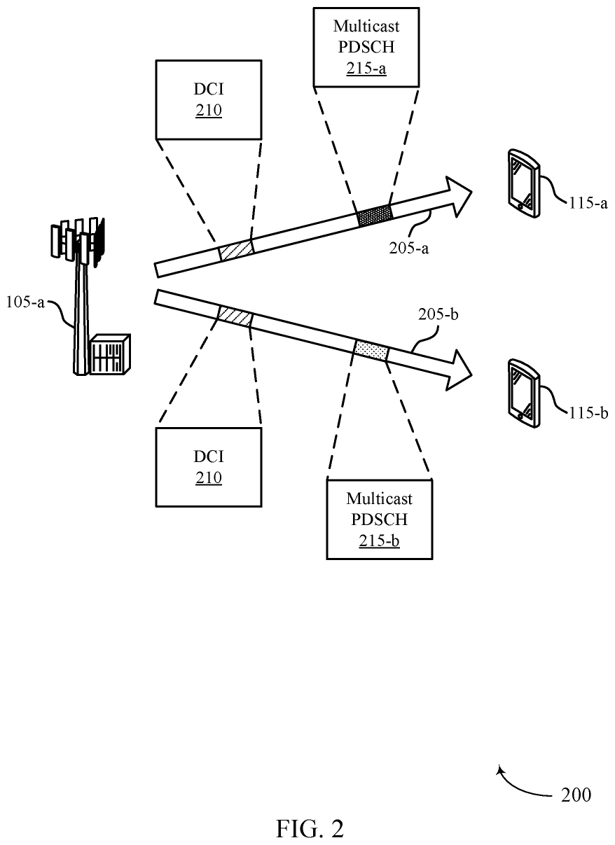

FIG. 2 illustrates an example of a wireless communications system 200 that supports multicast grants to UEs of different capabilities using a single DCI in accordance with aspects of the present disclosure. In some examples, wireless communications system 200 may implement aspects of wireless communications system 100. For example, wireless communications system 200 may include a base station 105-a, a UE 115-a, and a UE 115-b, which may represent examples of corresponding base stations 105 and UEs 115, respectively, as described with reference to FIG. 1. In some implementations, base station 105-a, UE 115-a, and UE 115-b may support multicast communications, where base station 105-a can transmit same multicast downlink messages to both UE 115-a and UE 115-b (e.g., on shared radio bearers, dedicated radio bearers, etc.) on corresponding carriers 205 (e.g., a first carrier 205-a for multicast communications with UE 115-a and a second carrier 205-b for multicast communications with UE 115-b). However, UE 115-a and UE 115-b may include different capabilities, such that is more efficient for base station 105-a to transmit the multicast downlink messages to UE 115-a and to UE 115-b with different parameters based on the different capabilities.

UE 115-a may be an NR-RedCap device (e.g., a UE class, an NR-Light UE, an NR-Lite UE, etc.) that has lower capabilities, includes fewer antennas, uses a reduced bandwidth, has limited battery capacity, and has a reduced processing capability than other UEs 115 (e.g., with relaxed timelines/latency and enhanced coverage recovery). UE 115-b may represent a non-NR-RedCap device (e.g., regular UE 115, standard UE 115, non-NR-Light UE 115, etc.) with higher capabilities. As such, base station 105-a may be unable to use a single PDSCH to convey a multicast data packet to both UE 115-a and UE 115-b without resulting in inefficient communications at either UE 115. For example, if the single PDSCH is configured for the sake of UE 115-a (e.g., NR-RedCap UE), then a higher than needed amount of resources may be used to signal the single PDSCH, resulting in higher power consumption and higher resource usage at UE 115-b (e.g., non-NR-RedCap UE). Alternatively, if the single PDSCH is configured for UE 115-b (e.g., non-NR-RedCap UE), then UE 115-a may be unable to successfully receive and decode the single PDSCH (e.g., based on needing a higher amount of resources to fully receive the multicast data packet). In some cases, base station 105-a may transmit separate DCIs (e.g., in corresponding PDCCHs) to UE 115-a and UE 115-b to schedule corresponding multicast PDSCHs based on the capabilities of each UE 115. However, the separate DCIs may increase the usage of resources allocated for PDCCHs, thereby resulting in inefficient communications.

As described herein, base station 105-a may transmit a DCI 210 (e.g., a single GC-DCI) to UE 115-a and UE 115-b (e.g., on first carrier 205-a and second carrier 205-b, respectively) to indicate two multicast PDSCHs 215, such as a first multicast PDSCH 215-a for NR-RedCap UEs (e.g., UE 115-a) and a second multicast PDSCH 215-b for non-NR-RedCap UEs (e.g., UE 115-b). In some implementations, each multicast PDSCH 215 may include different parameters from the other PDSCH 215. For example, second multicast PDSCH 215-b (e.g., for regular UEs, non-NR-RedCap UEs, UE 115-b, etc.) may use a higher MCS than first multicast PDSCH 215-a (e.g., for NR-RedCap UEs, UE 115-a, etc.). Additionally, the indicated multicast PDSCHs 215 may be either non-overlapping or partial overlapping.

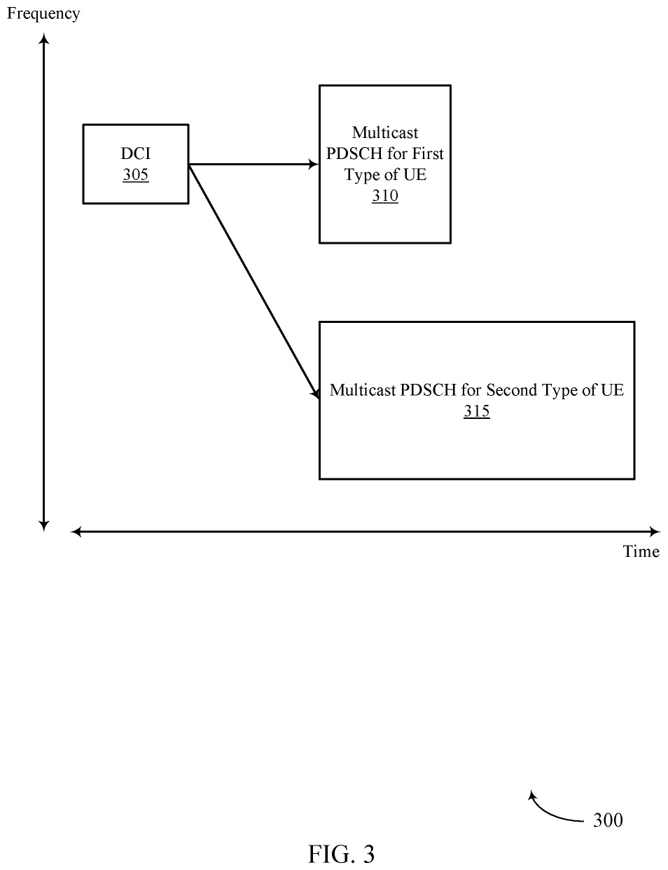

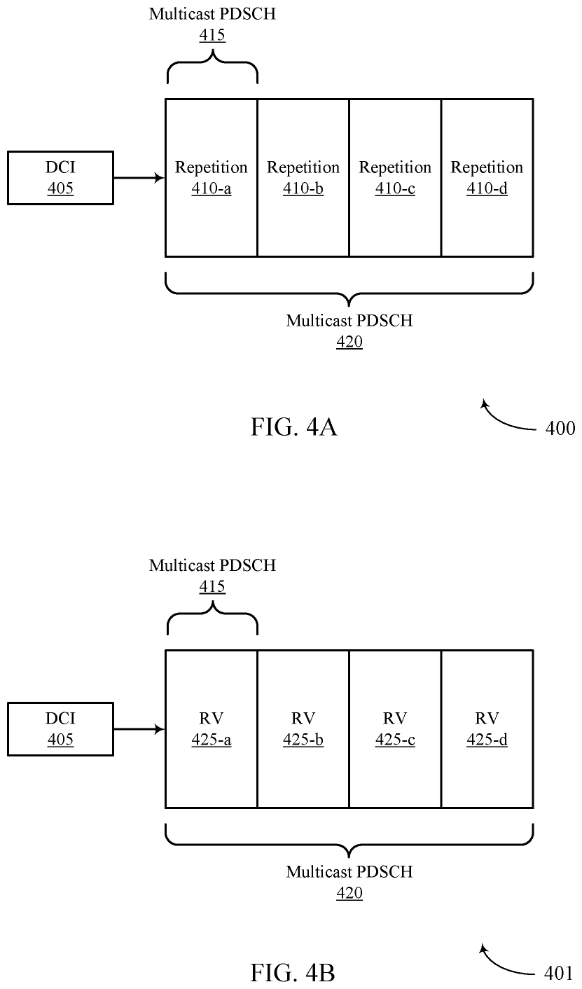

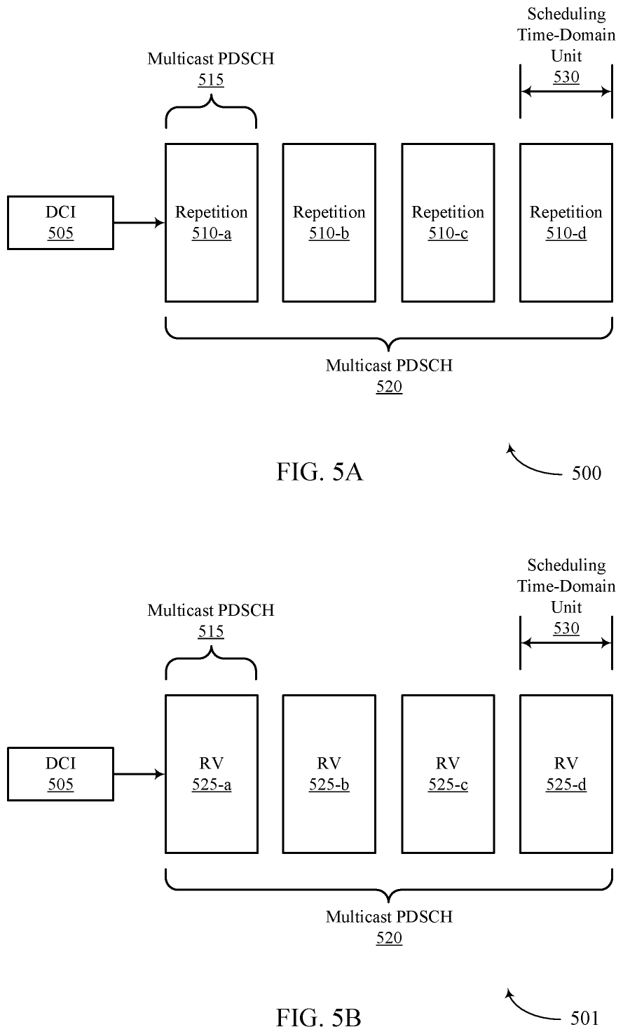

DCI 210 may contain information (e.g., transmission configurations) on two (2) sets of parameters for each multicast PDSCH 215. For example, the two (2) sets of parameters may include different MCSs, TDRAs, FDRAs, antenna port configurations, or a combination thereof for each multicast PDSCH 215. To reduce a size of DCI 210, the information on these sets of parameters for the two indicated multicast PDSCHs 215 may have some relations or restrictions and may have same or related values. For example, the two multicast PDSCHs 215 may be non-overlapping (e.g., described in more detail with reference to FIG. 3). Additionally or alternatively, the two multicast PDSCHs 215 may be partial overlapping within a scheduling time-domain unit (e.g., described in more detail with reference to FIGS. 4A and 4B) or across multiple scheduling time-domain units (e.g., described in more detail with reference to FIGS. 5A and 5B). For example, when the multicast PDSCHs 215 are at least partially, a time-domain resource allocation of first multicast PDSCH 215-a (e.g., for NR-RedCap UEs 115) may be divided into N parts (e.g., N>1), where a first part of the N parts may be used for second multicast PDSCH 215-b (e.g., for non-NR-RedCap UEs). In some implementations, the N parts may be within one scheduling time-domain unit (e.g., a slot, a mini-slot, etc.) or may be distributed across multiple scheduling time-domain units. Additionally, each part of the N parts may include repetitions of a same multicast PDSCH 215 (e.g., a multicast data packet) or may include different redundant versions of the same multicast PDSCH 215.

Subsequently, upon receiving DCI 210, each UE 115 may receive corresponding multicast PDSCHs parameters for a respective multicast PDSCH 215 from DCI 210 based on a corresponding type or capability of the UE 115. For example, UE 115-a may know its type or capabilities correspond to an NR-RedCap device and may identify a set of parameters for first multicast PDSCH 215-a in DCI 210. Additionally, UE 115-b may know its type or capabilities correspond to a non-NR-RedCap device and may identify a set of parameters for second multicast PDSCH 215-b in DCI 210. Accordingly, each UE 115 may then monitor for and receive a corresponding multicast PDSCH 215 based on the identified set of parameters for their type or capabilities. For example, UE 115-a may monitor for and receive first multicast PDSCH 215-a on first carrier 205-a, and UE 115-b may monitor for and receive second multicast PDSCH 215-b on second carrier 205-b.

For DCI 210 (e.g., the single GC-DCI indicating two multicast PDSCHs 215), a size of DCI 210 may have different options. For example, DCI 210 may include a size independent of other DCI sizes (e.g., legacy unicast DCI sizes, legacy multicast DCI sizes, etc.). Alternatively, DCI 210 may include a same DCI size as existing DCI formats (e.g., a same DCI size as legacy unicast DCIs, such as DCI formats 1_0, 1_1, 1_2, etc.). In some implementations, DCI 210 may include a same DCI size as a multicast DCI (e.g., legacy multicast DCI) that indicates a single PDSCH.

Prior to transmitting DCI 210, base station 105-a may transmit an activation message to the UEs 115, where the activation message indicates for the UEs 115 to receive the DCI 210 for configuring the different multicast PDSCHs 215. In some implementations, base station 105-a may determine activation of the DCI 210 (e.g., single GC-DCI indicating two multicast PDSCHs) based on a PDCCH load status. For example, if a PDCCH is low-loaded (e.g., a number of multicast sessions is small), base station 105-a may not transmit the activation message and may transmit two GC-DCIs to corresponding UEs 115 (e.g., a first GC-DCI for NR-RedCap UEs and a second GC-DCI for non-NR-RedCap UEs) to indicate two multicast PDSCHs per multicast session, respectively. Alternatively, if the PDCCH is high-loaded (e.g., the number of multicast sessions is large), base station 105-a may transmit the activation message and may then transmit the DCI 210 to indicate two multicast PDSCHs 215 per multicast session. In some implementations, the DCI 210 may be scrambled with a G-RNTI corresponding to base station 105-a. Additionally, when transmitting the activation message, base station 105-a may send the signaling to the UEs 115 to activate or deactivate DCI 210 indicating the two multicast PDSCHs via RRC signaling, a MAC control element (CE), DCI, or a combination thereof. If the activation message is sent by DCI, this DCI may be scrambled with a single cell RNTI (SC-RNTI) corresponding to base station 105-a.

By using DCI 210 to indicate the two multicast PDSCHs 215, wireless communications system 200 may reduce PDCCH resource consumption. Subsequently, wireless communications system 200 may then support multicast data transfer to co-existed non-NR-RedCap UEs (e.g., regular UEs) and NR-RedCap UEs. Additionally, the DCI 210 may increase a spectrum efficiency for base station 105-a (e.g., a cell of base station 105-a) based on the reduced PDCCH resource consumption.

FIG. 3 illustrates an example of a multicast downlink shared channel configuration 300 that supports multicast grants to UEs of different capabilities using a single DCI in accordance with aspects of the present disclosure. In some examples, multicast downlink shared channel configuration 300 may implement aspects of wireless communications systems 100 and 200. For example, a base station 105 may use multicast downlink shared channel configuration 300 to communicate with one or more UEs 115 based on types or capabilities of the UEs 115.

As described with reference to FIG. 2, the base station 105 may transmit a DCI 305 that indicates two (2) multicast PDSCHs. For example, the two (2) multicast PDSCHs may include a multicast PDSCH 310 for a first type of UE (e.g., a non-NR-RedCap UE, a regular UE, a standard UE, etc.) and a multicast PDSCH 315 for a second type of UE (e.g., an NR-RedCap UE, an NR-Light UE, etc.). Accordingly, DCI 305 may include two (2) sets of individual parameters, each set of individual parameters corresponding to a separate multicast PDSCH. Each set of individual parameters may contain one or more of the fields of an MCS, a TDRA, an FDRA, an antenna port configuration, or a combination thereof for each multicast PDSCH.

In some implementations, the two (2) PDSCHs may be non-overlapping. For example, a first set of time-frequency resources configured for multicast PDSCH 310 may be different than a second set of time-frequency resources configured for multicast PDSCH 315. Accordingly, after receiving DCI 305, any UEs 115 that are part of the first type of UE may identify the first set of time-frequency resources (e.g., along with additional corresponding parameters for multicast PDSCH 310) and may monitor the first set of time-frequency resources to receive multicast PDSCH 310. Additionally, any UEs 115 that are part of the second type of UE may identify the second set of time-frequency resources in DCI 305 (e.g., along with additional corresponding parameters for multicast PDSCH 315) and may monitor the second set of time-frequency resources to receive multicast PDSCH 315.

To reduce or limit the size of DCI 305, one or more fields in the sets of individual parameters for each multicast PDSCH may have same or related values across the two sets of individual parameters. For example, an FDRA type in each set of individual parameters may be a continuous RB allocation (e.g., resource allocation type 1), where the two parameter sets have a same frequency-domain resource length (e.g., a number of RBs, an RB group (RBG), etc.) and different indexes of a starting RB or a starting RBG for a respective multicast PDSCH. Additionally or alternatively, the two parameter sets may have a same start symbol but with different lengths (e.g., a different number of symbols for each multicast PDSCH). In some implementations, the two parameter sets may have a same demodulation reference signal (DMRS) setting, such as a same number of DMRS ports, a same position of DMRS ports, a same code division multiplexing (CDM) group of DMRS ports, or a combination thereof, but with different MCS values per multicast PDSCH. Additionally or alternatively, the two parameter sets may have a same MCS value but with a different number of layers (e.g., different number of antenna ports). These examples of same or related values across the two set of individual parameters for each multicast PDSCH is not meant to be an exhaustive list, and additional parameters not listed herein may have same or similar values for each multicast PDSCH.

FIGS. 4A and 4B illustrate examples of time-domain resource allocations 400 and 401 that support multicast grants to UEs of different capabilities using a single DCI in accordance with aspects of the present disclosure. In some examples, time-domain resource allocations 400 and 401 may implement aspects of wireless communications systems 100 and 200. For example, a base station 105 may use time-domain resource allocations 400 and 401 to communicate with one or more UEs 115 based on types or capabilities of the UEs 115.

As described with reference to FIG. 2, the base station 105 may transmit a DCI 405 that indicates two (2) multicast PDSCHs. For example, the two (2) multicast PDSCHs may include a multicast PDSCH 415 for a first type of UE (e.g., a non-NR-RedCap UE, a regular UE, a standard UE, etc.) and a multicast PDSCH 420 for a second type of UE (e.g., an NR-RedCap UE, an NR-Light UE, etc.).

In some implementations, the two PDSCHs may be partial overlapping within a scheduling time-domain unit (e.g., a slot, a mini-slot, etc.). For example, a time-domain allocation for multicast PDSCH 420 (e.g., for NR-RedCap UEs) may be divided into N parts, where N>1. Accordingly, a first part of the N parts configured for multicast PDSCH 20 may then be used for multicast PDSCH 415 for non-NR-RedCap UEs (e.g., partially overlapping multicast PDSCHs). That is, based on the reduced capabilities of NR-RedCap UEs, multicast PDSCH 420 may span a larger amount of time-frequency resources to enable the NR-RedCap UEs to receive and decode a multicast data packet, whereas the non-NR-RedCap UEs may receive and decode the multicast data packet in a lesser amount of time-frequency resources partially overlapping with the time-frequency resources of multicast PDSCH 420. Additionally, the N parts may be within one scheduling time-domain unit (e.g., one slot, one mini-slot, etc.).

In some implementations, each part of the N parts may be used in different ways to transmit the multicast PDSCHs to corresponding UEs 115. For example, as shown in FIG. 4A, the base station 105 may transmit different repetitions 410 of a multicast PDSCH for the different types of UEs 115. With N parts being equal to four (4) parts, the base station 105 may transmit a first repetition 410-a, a second repetition 410-b, a third repetition 410-c, and a fourth repetition 410-d of the multicast PDSCH. Accordingly, first repetition 410-a of the multicast PDSCH may be seen as multicast PDSCH 415 for the first type of UE (e.g., non-NR-RedCap UEs), and all the repetitions 410 taken together may be seen as multicast PDSCH 420 for the second type of UE (e.g., NR-RedCap UEs). For the repetitions 410, the base station 105 may encode a set of multicast data packet information bits and may rate match and map the encoded set of multicast data packet information bits to the first part of the N parts (e.g., a first part of multicast PDSCH 420 for NR-RedCap UEs). Subsequently, the remaining parts of the N parts (e.g., other parts of the time-domain allocation for multicast PDSCH 420) may be a repetition of the first part.

Additionally or alternatively, as shown in FIG. 4B, the base station 105 may transmit a multicast data packet to both types of UEs 115 using different RVs 425. For example, with N parts being equal to four (4) parts, the base station 105 may transmit a first RV 425-a, a second RV 425-b, a third RV 425-c, and a fourth RV 425-d for the multicast data packet. For the different RVs 425, the base station 105 may encode a set of multicast data packet information bits and may rate match the set of multicast data packet information bits into the multiple RVs 425. Subsequently, the base station 105 may map these RVs 425 into the multiple N parts of the time-domain allocation for multicast PDSCH 420 with a given order. Accordingly, first RV 425-a for the set of multicast data packet information bits may be seen as multicast PDSCH 415 for the first type of UE (e.g., non-NR-RedCap UEs), and all RVs 425 for the set of multicast data packet information bits may be seen as multicast PDSCH 420 for the second type of UE (e.g., NR-RedCap UEs).

To indicate such PDSCH configurations as shown in FIGS. 4A and 4B for partially overlapping multicast PDSCHs within a same scheduling time-domain unit, the DCI 405 may include information for the TDRA and FDRA of multicast PDSCH 420 (e.g., for NR-RedCap UEs), a number of the N parts, a choice between multiple repetitions 410 (e.g., as shown in FIG. 4A) or multiple RVs 425 (e.g., as shown in FIG. 4B), a mapping order of the RVs 425 (e.g., if not pre-configured, configured by RRC signaling, etc.), or a combination thereof.

FIGS. 5A and 5B illustrate examples of time-domain resource allocations 500 and 501 that supports multicast grants to UEs of different capabilities using a single DCI in accordance with aspects of the present disclosure. In some examples, time-domain resource allocations 500 and 501 may implement aspects of wireless communications systems 100 and 200. For example, a base station 105 may use time-domain resource allocations 500 and 501 to communicate with one or more UEs 115 based on types or capabilities of the UEs 115.

As described with reference to FIG. 2, the base station 105 may transmit a DCI 505 that indicates two (2) multicast PDSCHs. For example, the two (2) multicast PDSCHs may include a multicast PDSCH 515 for a first type of UE (e.g., a non-NR-RedCap UE, a regular UE, a standard UE, etc.) and a multicast PDSCH 520 for a second type of UE (e.g., an NR-RedCap UE, an NR-Light UE).

In some implementations, the two (2) PDSCHs may be partial overlapping across multiple scheduling time-domain units 530 (e.g., multiple slots, multiple mini-slots, etc.). Accordingly, the techniques described with reference to FIGS. 4A and 4B may then be extended to be used across multiple scheduling time-domain units 530. For example, as shown in FIG. 5A and described with reference to FIG. 4A, multiple repetitions 510 of a set of multicast data packet information bits may be transmitted for each multicast PDSCH, where a first repetition 510-a is used for multicast PDSCH 515 (e.g., for non-NR-RedCap UEs) and all repetitions 510 are used for multicast PDSCH 520 (e.g., for NR-RedCap UEs), but each repetition 510 may be transmitted in a separate scheduling time-domain unit 530. Additionally or alternatively, as shown in FIG. 5B and described with reference to FIG. 4B, multiple RVs 525 of the set of multicast data packet information bits may be transmitted for each multicast PDSCH, where a first RV 525-a is used for multicast PDSCH 515 (e.g., for non-NR-RedCap UEs) and all RVs 525 are used for multicast PDSCH 520 (e.g., for NR-RedCap UEs), but each RV 525 may be transmitted in a separate scheduling time-domain unit 530.

To indicate such PDSCH configurations as shown in FIGS. 5A and 5B for partially overlapping multicast PDSCHs across multiple scheduling time-domain units, DCI 505 may include information for a TDRA and FDRA of multicast PDSCH 515 (e.g., for non-NR-RedCap UEs) in a first scheduling time-domain unit with the remaining scheduling time-domain units having a same resource allocation, a number of scheduling time-domain units (e.g., number of parts), a choice between multiple repetitions 510 (e.g., as shown in FIG. 5A) or multiple RVs 525 (e.g., as shown in FIG. 5B), a mapping order of the RVs 525 (e.g., if not pre-configured, configured by RRC signaling, etc.), or a combination thereof.

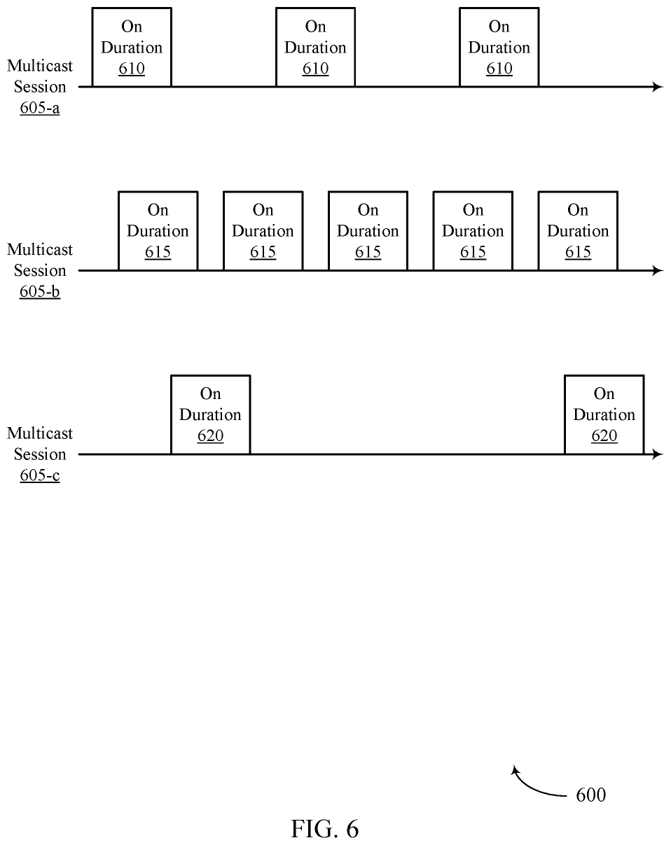

FIG. 6 illustrates an example of a multicast configuration 600 in accordance with aspects of the present disclosure. In some examples, multicast configuration 600 may implement aspects of wireless communications systems 100 and 200. For example, a base station 105 may communicate with multiple UEs 115 (e.g., including different types of UEs 115 with different capabilities, such as NR-RedCap UEs and non-NR-RedCap UEs) using multicast configuration 600 (e.g., MBMS session, MBMS communications, etc.).

In some cases, the base station 105 may send a single carrier multicast control channel (SC-MCCH) to the multiple UEs 115, where the SC-MCCH indicates whose DCI of the multiple UEs 115 is scrambled with a SC-RNTI to all UEs in a cell for the base station 105. Additionally, with the SC-MCCH, the base station 105 may configure a number of multicast sessions 605, each multicast session 605 associated with a G-RNTI value and a discontinuous reception (DRX) profile. That is, each multicast session 605 may include a respective cycle period, offset, on-duration length, inactivity-timer length, etc. For example, as shown in FIG. 6, a first multicast session 605-a may include a first periodicity of one or more on-durations 610, a second multicast session 605-b may include a second periodicity of one or more on-durations 615, and a third multicast session 605-c may include a third periodicity of one or more on-durations 620. If a UE 115 receives multiple multicast sessions 605, the UE 115 may monitor a PDCCH at each on-duration occasions of each multicast session 605 according to the different DRX profiles of each multicast session 605. For example, the UE 115 may attempt to blindly decode any PDCCH identified during an on-duration of a corresponding multicast session 605 to search for a DCI which is scrambled with the configured G-RNTI values.

As such, with different types of UEs (e.g., non-NR-RedCap UEs and NR-RedCap UEs), if separate PDCCHs are configured and signaled to indicate corresponding PDSCHs for the different types of UEs, a PDCCH resource pool may become exhausted to signal the separate PDCCHs for each on-duration of each multicast session 605. By using the techniques described herein for signaling a single DCI to indicate multiple PDSCHs for the different types of UEs, the base station 105 may use and support multiple multicast sessions 605 with different or same on-durations for different types of UEs (e.g., co-existence of different types of UEs) without using up the PDCCH resource pool.

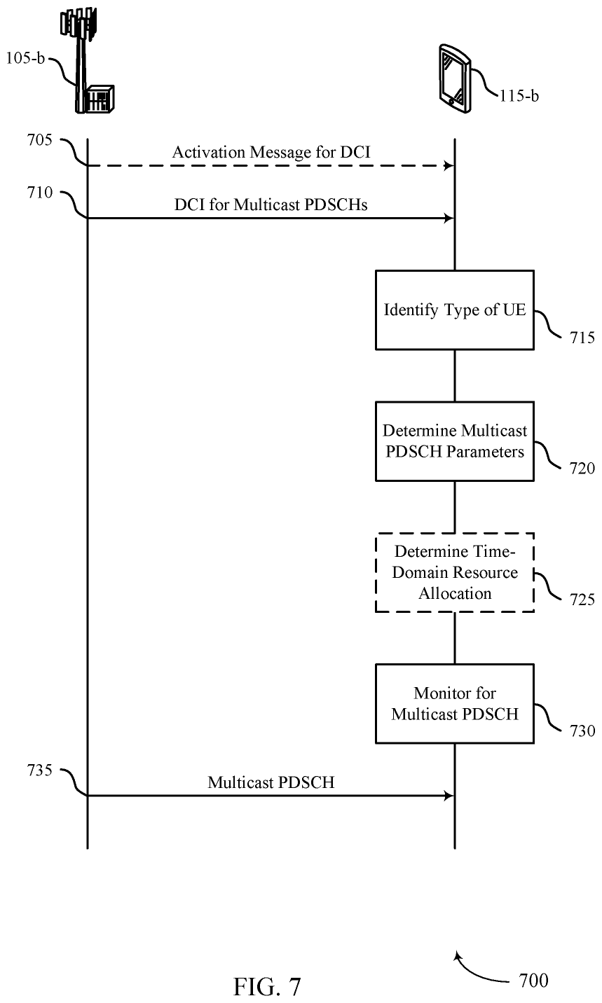

FIG. 7 illustrates an example of a process flow 700 that supports multicast grants to UEs of different capabilities using a single DCI in accordance with aspects of the present disclosure. In some examples, process flow 700 may implement aspects of wireless communications systems 100 and 200. For example, process flow 700 may include a base station 105-b and a UE 115-b, which may represent examples of corresponding base stations 105 and UEs 115, respectively, as described with reference to FIGS. 1-6.

In the following description of the process flow 700, the operations between UE 115-b and base station 105-b may be transmitted in a different order than the exemplary order shown, or the operations performed by UE 115-b and base station 105-b may be performed in different orders or at different times. Certain operations may also be left out of the process flow 700, or other operations may be added to the process flow 700. It is to be understood that while UE 115-b and base station 105-b are shown performing a number of the operations of process flow 700, any wireless device may perform the operations shown.

At 705, UE 115-b may receive, from base station 105-b and in advance of receipt of a DCI message, an activation message indicating that DCI messages received from base station 105-b would include an indication of a first multicast downlink shared channel and a second multicast downlink shared channel. In some implementations, UE 115-b may receive, from base station 105-b, the activation message via RRC signaling or a MAC CE or DCI. For example, UE 115-b may receive, from base station 105-b, the activation message via DCI which is scrambled with an SC-RNTI specific to base station 105-b. In some implementations, base station 105-b may determine to transmit the activation message for the DCI message based on a load status of a downlink control channel for a set of UEs including UE 115-b (e.g., whether a PDCCH is low-loaded or high-loaded).

At 710, UE 115-b may receive, from base station 105-b, the DCI message including the indication of the first multicast downlink shared channel (e.g., PDSCH) and the second multicast downlink shared channel, where the first multicast downlink shared channel is configured for a first type of UE and the second multicast downlink shared channel is configured for a second type of UE different from the first type of UE (e.g., non-NR-RedCap UEs and NR-RedCap UEs). For example, the first type of UE and the second type of UE may have different capabilities, different numbers of antennas, different communication bandwidths, different battery capacities, different processing capabilities, or a combination thereof.

At 715, UE 115-b may identify that UE 115-b is of the first type of UE.

At 720, UE 115-b may determine, from the DCI message, a set of multicast downlink shared channel parameters for receiving the first multicast downlink shared channel based on UE 115-b being of the first type of UE. In some implementations, UE 115-b may receive, in the DCI, individual sets of multicast downlink shared channel parameters for the first multicast downlink shared channel and the second multicast downlink shared channel and may determine which individual set of multicast downlink shared channel parameters to use based on its type. For example, the individual sets of multicast downlink shared channel parameters may include an MCS, a TDRA, an FDRA, an antenna ports configuration, or a combination thereof for each of the first multicast downlink shared channel and the second multicast downlink shared channel. Additionally, in some implementations, one or more parameters of the individual sets of multicast downlink shared channel parameters may be the same for the first multicast downlink shared channel and the second multicast downlink shared channel.

At 725, UE 115-b may determine a time-domain resource allocation for at least one of the first multicast downlink shared channel and the second multicast downlink shared channel based on the DCI message, where the time-domain resource allocation is divided into a set of parts (e.g., N parts).

At 730, UE 115-b may monitor for the first multicast downlink shared channel based on the set of multicast downlink shared channel parameters. In some implementations, UE 115-b may monitor for the multicast downlink shared channel in a first part of the set of parts based on the UE being of the first type, where the first type of UE has at least one of the following: more capabilities than the second type of UE, more antennas than the second type of UE, larger or more communication bandwidths than the second type of UE, greater battery capacity than the second type of UE, or greater processing capabilities than the second type of UE (e.g., the first type of UE is a non-NR-RedCap device, a regular UE, a standard UE, etc.). Additionally or alternatively, UE 115-b may monitor for the multicast downlink shared channel across all parts of the set of parts based on the UE being of the first type, where the first type of UE has at least one of the following: fewer capabilities than the second type of UE, fewer antennas than the second type of UE, smaller or fewer communication bandwidths than the second type of UE, lesser battery capacity than the second type of UE, or lesser processing capabilities than the second type of UE (e.g., the first type of UE is an NR-RedCap device).

In some implementations, UE 115-b may receive, from base station 105-b, a TDRA and an FDRA based on the UE being of the first type of UE, a number of the set of parts, an additional indication of using repetitions or different RVs for the first multicast downlink shared channel in each part of the set of parts, an RV mapping order, or a combination thereof. For example, each part of the set of parts may include a repetition of the second multicast downlink shared channel. Alternatively, each part of the set of parts may include a different RV of the second multicast downlink shared channel. Additionally, the set of parts may be located within a single scheduling time-domain unit (e.g., a single slot, a single mini-slot that includes multiple symbols within a slot, etc.), or each part is located in a separate scheduling time-domain unit (e.g., separate slots, separate mini-slots, etc.).

At 735, base station 105-b may transmit, to a set of UEs 115 at least including UE 115-b, both the first multicast downlink shared channel and the second multicast downlink shared channel in accordance with corresponding multicast downlink shared channel parameters included in the DCI message.

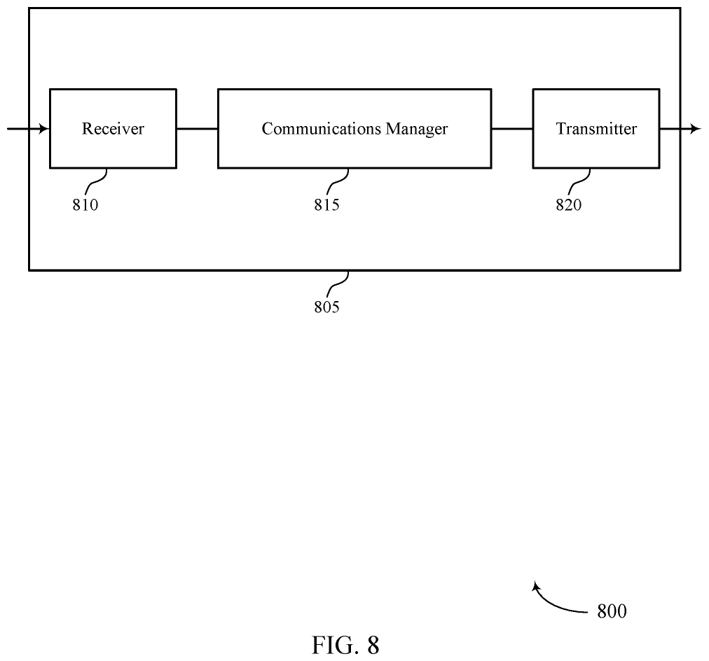

FIG. 8 shows a block diagram 800 of a device 805 that supports multicast grants to UEs of different capabilities using a single DCI in accordance with aspects of the present disclosure. The device 805 may be an example of aspects of a UE 115 as described herein. The device 805 may include a receiver 810, a communications manager 815, and a transmitter 820. The device 805 may also include a processor. Each of these components may be in communication with one another (e.g., via one or more buses).

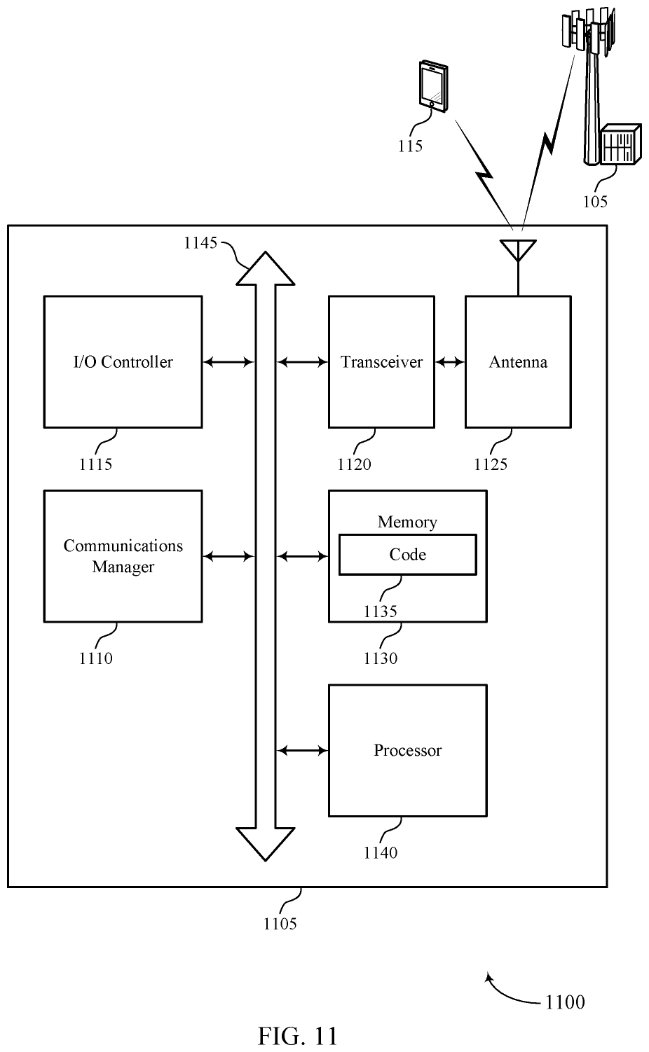

The receiver 810 may receive information such as packets, user data, or control information associated with various information channels (e.g., control channels, data channels, and information related to multicast grants to UEs of different capabilities using a single DCI, etc.). Information may be passed on to other components of the device 805. The receiver 810 may be an example of aspects of the transceiver 1120 described with reference to FIG. 11. The receiver 810 may utilize a single antenna or a set of antennas.

The communications manager 815 may receive, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE. In some implementations, the communications manager 815 may identify that the UE is of the first type of UE. Subsequently, the communications manager 815 may determine, from the DCI message, a set of multicast downlink shared channel parameters for receiving the first multicast downlink shared channel based on the UE being of the first type of UE. Additionally, the communications manager 815 may monitor for the first multicast downlink shared channel based on the set of multicast downlink shared channel parameters. The communications manager 815 may be an example of aspects of the communications manager 1110 described herein.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

In some examples, the communications manager 815 may be implemented as an integrated circuit or chipset for a mobile device modem, and the receiver 810 and transmitter 820 may be implemented as analog components (e.g., amplifiers, filters, antennas) coupled with the mobile device modem to enable wireless transmission and reception over one or more bands.

The communications manager 815 as described herein may be implemented to realize one or more potential advantages. One implementation may allow the device 805 to determine UE type-specific parameters for a PDSCH from a DCI that is carrying multiple sets of parameters for PDSCHs configured for different types of UEs. Accordingly, the device 805 may expend less computing and signaling resources that would have been used to receive and decode a PDSCH not optimally configured for the device 805, thereby increasing battery life. For example, if a PDSCH is configured for a reduced capability device, the device 805, having higher capabilities, may expend processing power and battery life to receive and decode the PDSCH across a higher amount of radio resources needed by the reduced capability device for successful reception of the PDSCH. By using the single DCI to carry parameters for different PDSCHs, the device 805 may identify which parameters are intended for a type of UE corresponding to the device 805, which may result in more efficient communications (e.g., less signaling overhead, less processing, longer battery life, etc.).

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

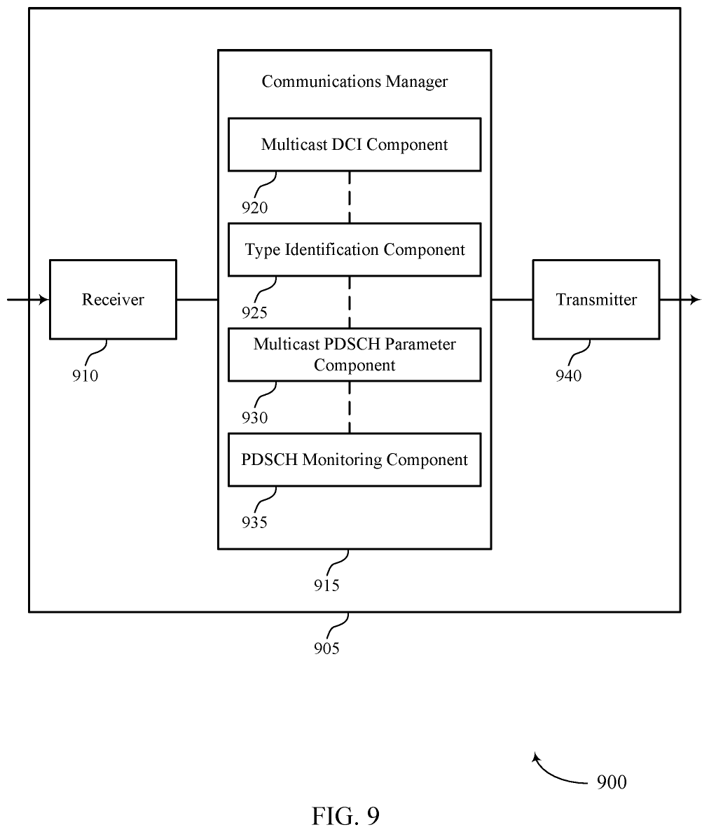

FIG. 9 shows a block diagram 900 of a device 905 that supports multicast grants to UEs of different capabilities using a single DCI in accordance with aspects of the present disclosure. The device 905 may be an example of aspects of a device 805, or a UE 115 as described herein. The device 905 may include a receiver 910, a communications manager 915, and a transmitter 940. The device 905 may also include a processor. Each of these components may be in communication with one another (e.g., via one or more buses).

The receiver 910 may receive information such as packets, user data, or control information associated with various information channels (e.g., control channels, data channels, and information related to multicast grants to UEs of different capabilities using a single DCI, etc.). Information may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include a multicast DCI component 920, a type identification component 925, a multicast PDSCH parameter component 930, and a PDSCH monitoring component 935. The communications manager 915 may be an example of aspects of the communications manager 1110 described herein.

The multicast DCI component 920 may receive, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE.

The type identification component 925 may identify that the UE is of the first type of UE.

The multicast PDSCH parameter component 930 may determine, from the DCI message, a set of multicast downlink shared channel parameters for receiving the first multicast downlink shared channel based on the UE being of the first type of UE.

The PDSCH monitoring component 935 may monitor for the first multicast downlink shared channel based on the set of multicast downlink shared channel parameters.

Based on determining a set of multicast downlink shared channel parameters for receiving a corresponding multicast downlink shared channel based on a type of a UE 115 as described herein, a processor of the UE 115 (e.g., controlling the receiver 910, the transmitter 940, or the transceiver 1120 as described with reference to FIG. 11) may more efficiently identify a configured PDSCH for the UE 115, resulting in less signaling overhead that would be needed to signal separate DCIs for different PDSCHs. The lesser signaling overhead may result in the processor of the UE 115 to save power at the UE 115 by reducing the number of downlink messages decoded.

The transmitter 940 may transmit signals generated by other components of the device 905. In some examples, the transmitter 940 may be collocated with a receiver 910 in a transceiver module. For example, the transmitter 940 may be an example of aspects of the transceiver 1120 described with reference to FIG. 11. The transmitter 940 may utilize a single antenna or a set of antennas.

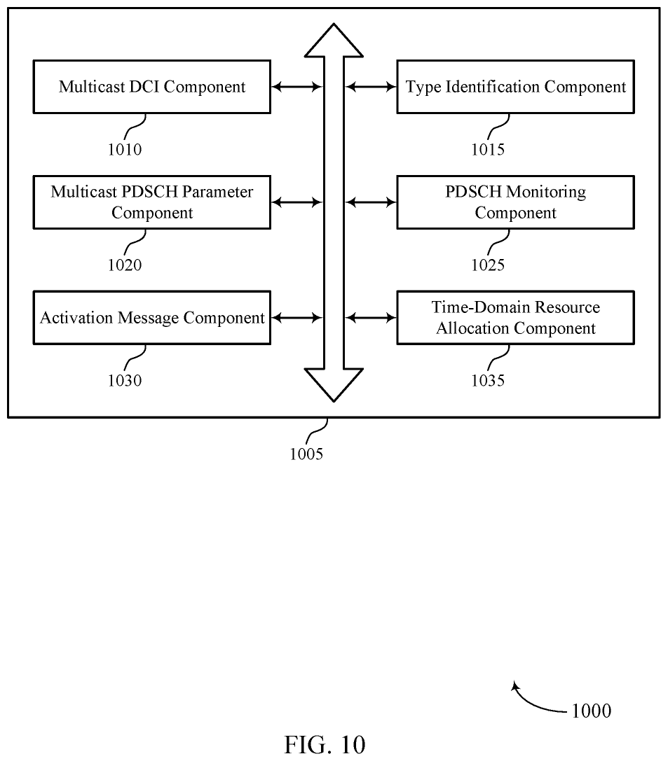

FIG. 10 shows a block diagram 1000 of a communications manager 1005 that supports multicast grants to UEs of different capabilities using a single DCI in accordance with aspects of the present disclosure. The communications manager 1005 may be an example of aspects of a communications manager 815, a communications manager 915, or a communications manager 1110 described herein. The communications manager 1005 may include a multicast DCI component 1010, a type identification component 1015, a multicast PDSCH parameter component 1020, a PDSCH monitoring component 1025, an activation message component 1030, and a time-domain resource allocation component 1035. Each of these modules may communicate, directly or indirectly, with one another (e.g., via one or more buses).

The multicast DCI component 1010 may receive, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE. In some cases, the first type of UE and the second type of UE may have different capabilities, different numbers of antennas, different communication bandwidths, different battery capacities, different processing capabilities, or a combination thereof.

The type identification component 1015 may identify that the UE is of the first type of UE.

The multicast PDSCH parameter component 1020 may determine, from the DCI message, a set of multicast downlink shared channel parameters for receiving the first multicast downlink shared channel based on the UE being of the first type of UE. In some examples, the multicast PDSCH parameter component 1020 may receive individual sets of multicast downlink shared channel parameters in the DCI for the first multicast downlink shared channel and the second multicast downlink shared channel. In some cases, the individual sets of multicast downlink shared channel parameters may include an MCS, a TDRA, an FDRA, an antenna ports configuration, or a combination thereof for each of the first multicast downlink shared channel and the second multicast downlink shared channel. Additionally, one or more parameters of the individual sets of multicast downlink shared channel parameters may be the same for the first multicast downlink shared channel and the second multicast downlink shared channel.

The PDSCH monitoring component 1025 may monitor for the first multicast downlink shared channel based on the set of multicast downlink shared channel parameters.

The activation message component 1030 may receive, from the base station and in advance of receipt of the DCI message, an activation message indicating that DCI messages received from the base station would include the indication. In some examples, the activation message component 1030 may receive, from the base station, the activation message via RRC signaling or a MAC CE or DCI. Additionally, the activation message component 1030 may receive, from the base station, the activation message via DCI which is scrambled with an SC-RNTI specific to the base station.

The time-domain resource allocation component 1035 may determine a time-domain resource allocation for at least one of the first multicast downlink shared channel and the second multicast downlink shared channel based on the DCI message, where the time-domain resource allocation is divided into a set of parts. In some examples, the time-domain resource allocation component 1035 may monitor for the first multicast downlink shared channel in a first part of the set of parts based on the UE being of the first type, where the first type of UE has at least one of the following: more capabilities than the second type of UE, more antennas than the second type of UE, larger or more communication bandwidths than the second type of UE, greater battery capacity than the second type of UE, or greater processing capabilities than the second type of UE. Additionally or alternatively, the time-domain resource allocation component 1035 may monitor for the first multicast downlink shared channel across all parts of the set of parts based on the UE being of the first type, where the first type of UE has at least one of the following: fewer capabilities than the second type of UE, fewer antennas than the second type of UE, smaller or fewer communication bandwidths than the second type of UE, lesser battery capacity than the second type of UE, or lesser processing capabilities than the second type of UE.

In some examples, the time-domain resource allocation component 1035 may receive, from the base station, a TDRA and an FDRA based on the UE being of the first type of UE, a number of the set of parts, an additional indication of using repetitions or different RVs for the first multicast downlink shared channel in each part of the set of parts, an RV mapping order, or a combination thereof. In some cases, each part of the set of parts may include a repetition of the second multicast downlink shared channel. Alternatively, each part of the set of parts may include a different RV of the second multicast downlink shared channel. In some cases, the set of parts may be located within a single scheduling time-domain unit, or each part may be located in a separate scheduling time-domain unit. For example, a scheduling time-domain unit may include a slot, a mini-slot, or a combination thereof.

FIG. 11 shows a diagram of a system 1100 including a device 1105 that supports multicast grants to UEs of different capabilities using a single DCI in accordance with aspects of the present disclosure. The device 1105 may be an example of or include the components of device 805, device 905, or a UE 115 as described herein. The device 1105 may include components for bi-directional voice and data communications including components for transmitting and receiving communications, including a communications manager 1110, an I/O controller 1115, a transceiver 1120, an antenna 1125, memory 1130, and a processor 1140. These components may be in electronic communication via one or more buses (e.g., bus 1145).

The communications manager 1110 may receive, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE. In some implementations, the communications manager 1110 may identify that the UE is of the first type of UE. Subsequently, the communications manager 1110 may determine, from the DCI message, a set of multicast downlink shared channel parameters for receiving the first multicast downlink shared channel based on the UE being of the first type of UE. Additionally, the communications manager 1110 may monitor for the first multicast downlink shared channel based on the set of multicast downlink shared channel parameters.

The I/O controller 1115 may manage input and output signals for the device 1105. The I/O controller 1115 may also manage peripherals not integrated into the device 1105. In some cases, the I/O controller 1115 may represent a physical connection or port to an external peripheral. In some cases, the I/O controller 1115 may utilize an operating system such as iOS®, ANDROID®, MS-DOS®, MS-WINDOWS®, OS/2®, UNIX®, LINUX®, or another known operating system. In other cases, the I/O controller 1115 may represent or interact with a modem, a keyboard, a mouse, a touchscreen, or a similar device. In some cases, the I/O controller 1115 may be implemented as part of a processor. In some cases, a user may interact with the device 1105 via the I/O controller 1115 or via hardware components controlled by the I/O controller 1115.

The transceiver 1120 may communicate bi-directionally, via one or more antennas, wired, or wireless links as described above. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include random-access memory (RAM) and read-only memory (ROM). The memory 1130 may store computer-readable, computer-executable code 1135 including instructions that, when executed, cause the processor to perform various functions described herein. In some cases, the memory 1130 may contain, among other things, a basic I/O system (BIOS) which may control basic hardware or software operation such as the interaction with peripheral components or devices.

The processor 1140 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1140 may be configured to operate a memory array using a memory controller. In other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting multicast grants to UEs of different capabilities using a single DCI).

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

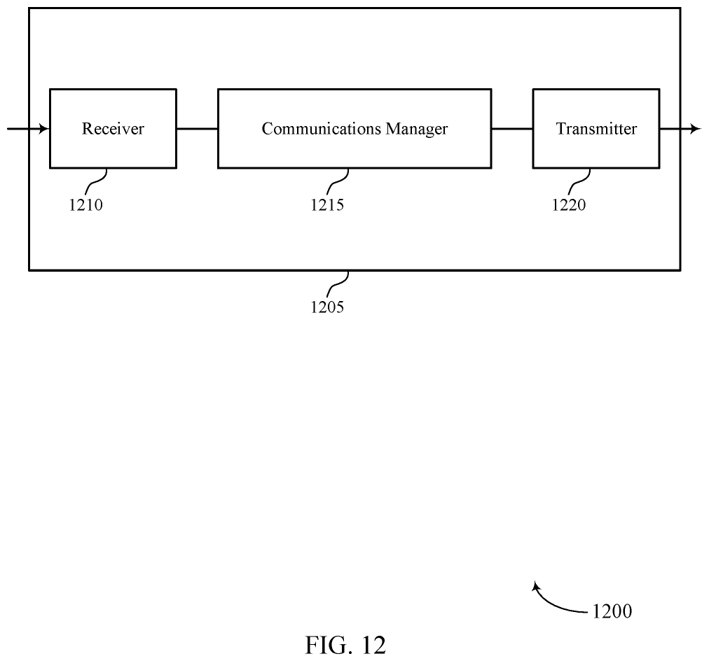

FIG. 12 shows a block diagram 1200 of a device 1205 that supports multicast grants to UEs of different capabilities using a single DCI in accordance with aspects of the present disclosure. The device 1205 may be an example of aspects of a base station 105 as described herein. The device 1205 may include a receiver 1210, a communications manager 1215, and a transmitter 1220. The device 1205 may also include a processor. Each of these components may be in communication with one another (e.g., via one or more buses).

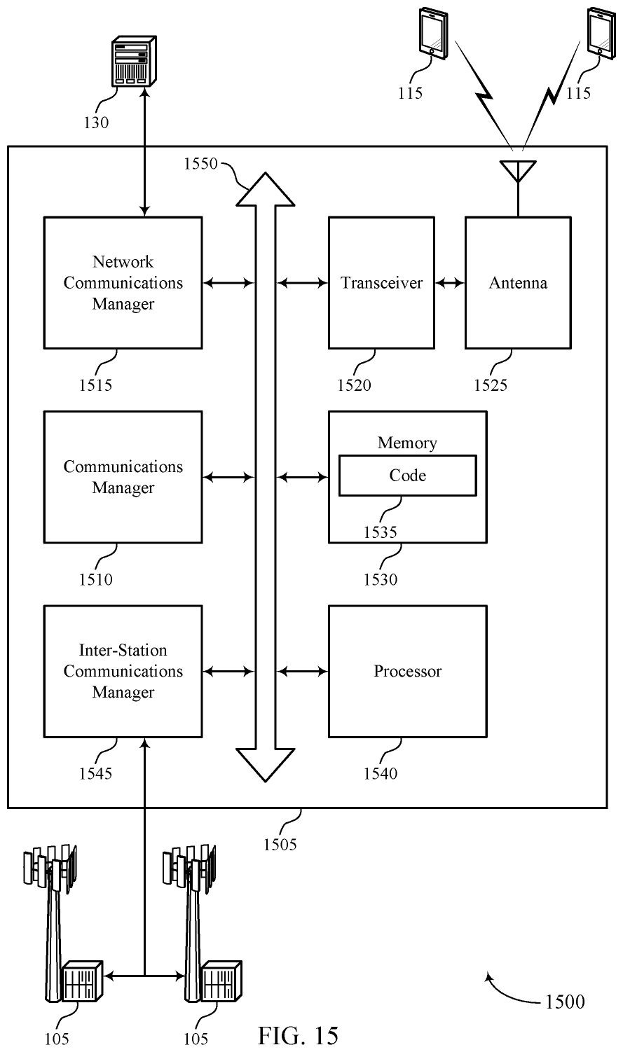

The receiver 1210 may receive information such as packets, user data, or control information associated with various information channels (e.g., control channels, data channels, and information related to multicast grants to UEs of different capabilities using a single DCI, etc.). Information may be passed on to other components of the device 1205. The receiver 1210 may be an example of aspects of the transceiver 1520 described with reference to FIG. 15. The receiver 1210 may utilize a single antenna or a set of antennas.

The communications manager 1215 may identify that a set of UEs in communication with a cell of the base station include at least two different types of UEs, including at least a first type of UE and a second type of UE. In some implementations, the communications manager 1215 may transmit, to the set of UEs, a DCI message including an indication of a first multicast downlink shared channel being configured for the first type of UE and a second multicast downlink shared channel being configured for the second type of UE. Additionally, the communications manager 1215 may transmit, to the set of UEs, both the first multicast downlink shared channel and the second multicast downlink shared channel in accordance with corresponding multicast downlink shared channel parameters included in the DCI message. The communications manager 1215 may be an example of aspects of the communications manager 1510 described herein.

The communications manager 1215, or its sub-components, may be implemented in hardware, code (e.g., software or firmware) executed by a processor, or any combination thereof. If implemented in code executed by a processor, the functions of the communications manager 1215, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1215, or its sub-components, may be physically located at various positions, including being distributed such that portions of functions are implemented at different physical locations by one or more physical components. In some examples, the communications manager 1215, or its sub-components, may be a separate and distinct component in accordance with various aspects of the present disclosure. In some examples, the communications manager 1215, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 1220 may transmit signals generated by other components of the device 1205. In some examples, the transmitter 1220 may be collocated with a receiver 1210 in a transceiver module. For example, the transmitter 1220 may be an example of aspects of the transceiver 1520 described with reference to FIG. 15. The transmitter 1220 may utilize a single antenna or a set of antennas.

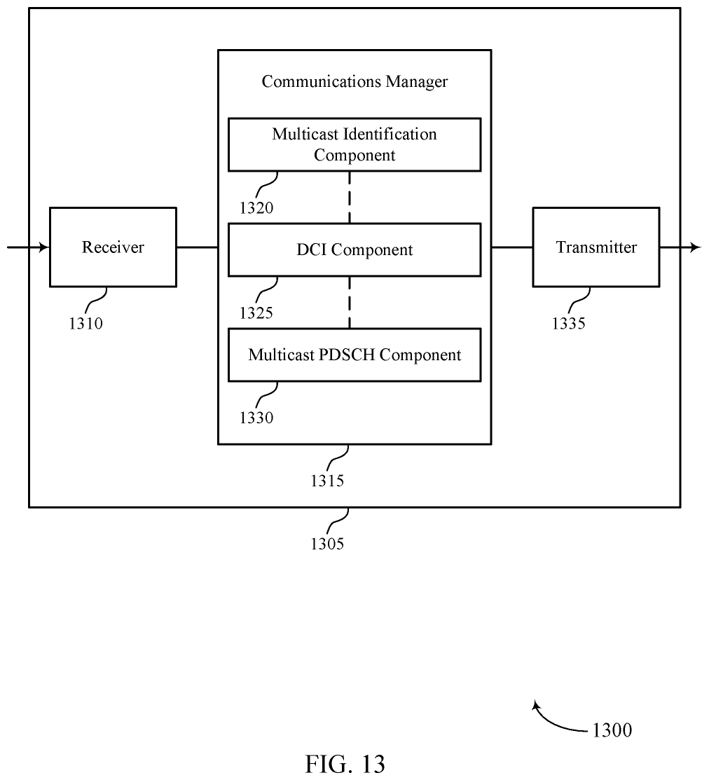

FIG. 13 shows a block diagram 1300 of a device 1305 that supports multicast grants to UEs of different capabilities using a single DCI in accordance with aspects of the present disclosure. The device 1305 may be an example of aspects of a device 1205, or a base station 105 as described herein. The device 1305 may include a receiver 1310, a communications manager 1315, and a transmitter 1335. The device 1305 may also include a processor. Each of these components may be in communication with one another (e.g., via one or more buses).

The receiver 1310 may receive information such as packets, user data, or control information associated with various information channels (e.g., control channels, data channels, and information related to multicast grants to UEs of different capabilities using a single DCI, etc.). Information may be passed on to other components of the device 1305. The receiver 1310 may be an example of aspects of the transceiver 1520 described with reference to FIG. 15. The receiver 1310 may utilize a single antenna or a set of antennas.

The communications manager 1315 may be an example of aspects of the communications manager 1215 as described herein. The communications manager 1315 may include a multicast identification component 1320, a DCI component 1325, and a multicast PDSCH component 1330. The communications manager 1315 may be an example of aspects of the communications manager 1510 described herein.

The multicast identification component 1320 may identify that a set of UEs in communication with a cell of the base station include at least two different types of UEs, including at least a first type of UE and a second type of UE.

The DCI component 1325 may transmit, to the set of UEs, a DCI message including an indication of a first multicast downlink shared channel being configured for the first type of UE and a second multicast downlink shared channel being configured for the second type of UE.

The multicast PDSCH component 1330 may transmit, to the set of UEs, both the first multicast downlink shared channel and the second multicast downlink shared channel in accordance with corresponding multicast downlink shared channel parameters included in the DCI message.

The transmitter 1335 may transmit signals generated by other components of the device 1305. In some examples, the transmitter 1335 may be collocated with a receiver 1310 in a transceiver module. For example, the transmitter 1335 may be an example of aspects of the transceiver 1520 described with reference to FIG. 15. The transmitter 1335 may utilize a single antenna or a set of antennas.

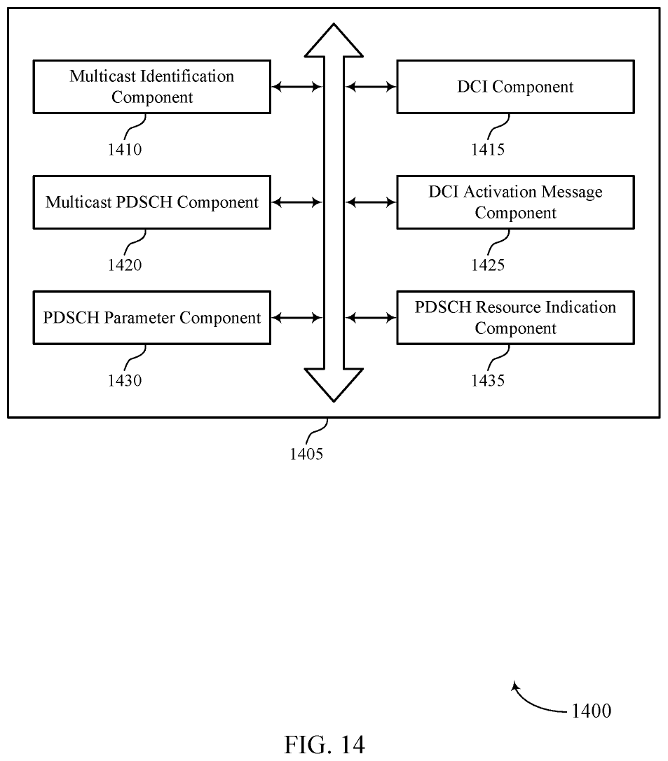

FIG. 14 shows a block diagram 1400 of a communications manager 1405 that supports multicast grants to UEs of different capabilities using a single DCI in accordance with aspects of the present disclosure. The communications manager 1405 may be an example of aspects of a communications manager 1215, a communications manager 1315, or a communications manager 1510 described herein. The communications manager 1405 may include a multicast identification component 1410, a DCI component 1415, a multicast PDSCH component 1420, a DCI activation message component 1425, a PDSCH parameter component 1430, and a PDSCH resource indication component 1435. Each of these modules may communicate, directly or indirectly, with one another (e.g., via one or more buses).

The multicast identification component 1410 may identify that a set of UEs in communication with a cell of the base station include at least two different types of UEs, including at least a first type of UE and a second type of UE. In some cases, the first type of UE and the second type of UE may have different capabilities, different numbers of antennas, different communication bandwidths, different battery capacities, different processing capabilities, or a combination thereof.

The DCI component 1415 may transmit, to the set of UEs, a DCI message including an indication of a first multicast downlink shared channel being configured for the first type of UE and a second multicast downlink shared channel being configured for the second type of UE.

The multicast PDSCH component 1420 may transmit, to the set of UEs, both the first multicast downlink shared channel and the second multicast downlink shared channel in accordance with corresponding multicast downlink shared channel parameters included in the DCI message. In some examples, the multicast PDSCH component 1420 may transmit, to the set of UEs, the first multicast downlink shared channel and the second multicast downlink shared channel in a time-domain resource allocation, where the time-domain resource allocation is divided into a set of parts. For example, the multicast PDSCH component 1420 may transmit the first multicast downlink shared channel in a first part of the set of parts, where the first multicast downlink shared channel is transmitted for the first type of UE, and may transmit the second multicast downlink shared channel across all parts of the set of parts, where the second downlink shared channel is transmitted for the second type of UE, where the first type of UE has at least one of the following: more capabilities than the second type of UE, more antennas than the second type of UE, larger or more communication bandwidths than the second type of UE, greater battery capacity than the second type of UE, or greater processing capabilities than the second type of UE. In some cases, each part of the set of parts may include a repetition of the second multicast downlink shared channel. Alternatively, each part of the set of parts may include a different RV of the second multicast downlink shared channel.

The DCI activation message component 1425 may transmit, to the set of UEs and in advance of transmission of the DCI message, an activation message indicating that DCI messages transmitted from the base station would include the indication. In some examples, the DCI activation message component 1425 may transmit, to the set of UEs, the activation message via RRC signaling or a MAC CE or DCI. Additionally, the DCI activation message component 1425 may transmit, to the set of UEs, the activation message via DCI which is scrambled with a SC-RNTI specific to the base station. In some examples, the DCI activation message component 1425 may determine to transmit the activation message for the DCI message based on a load status of a downlink control channel for the set of UEs.

The PDSCH parameter component 1430 may transmit individual sets of multicast downlink shared channel parameters for each of the first multicast downlink shared channel and the second multicast downlink shared channel. In some cases, the individual sets of multicast downlink shared channel parameters may include an MCS, a TDRA, an FDRA, an antenna ports configuration, or a combination thereof for each of the first multicast downlink shared channel and the second multicast downlink shared channel. Additionally, one or more parameters of the individual sets of multicast downlink shared channel parameters may be the same or are related values for each of the first multicast downlink shared channel and the second multicast downlink shared channel.

The PDSCH resource indication component 1435 may transmit, to the set of UEs, a time-domain resource assignment and a frequency-domain resource assignment for the first multicast downlink shared channel and the second multicast downlink shared channel based on a type of UE, a number of the set of parts, an additional indication of using repetitions or different RVs for the multicast downlink shared channel in each part of the set of parts, an RV mapping order, or a combination thereof. In some cases, the set of parts may be located within a single scheduling time-domain unit, or each part may be located in a separate scheduling time-domain unit. For example, a scheduling time-domain unit may include a slot, a mini-slot, or a combination thereof.

FIG. 15 shows a diagram of a system 1500 including a device 1505 that supports multicast grants to UEs of different capabilities using a single DCI in accordance with aspects of the present disclosure. The device 1505 may be an example of or include the components of device 1205, device 1305, or a base station 105 as described herein. The device 1505 may include components for bi-directional voice and data communications including components for transmitting and receiving communications, including a communications manager 1510, a network communications manager 1515, a transceiver 1520, an antenna 1525, memory 1530, a processor 1540, and an inter-station communications manager 1545. These components may be in electronic communication via one or more buses (e.g., bus 1550).

The communications manager 1510 may identify that a set of UEs in communication with a cell of the base station include at least two different types of UEs, including at least a first type of UE and a second type of UE. In some implementations, the communications manager 1510 may transmit, to the set of UEs, a DCI message including an indication of a first multicast downlink shared channel being configured for the first type of UE and a second multicast downlink shared channel being configured for the second type of UE. Additionally, the communications manager 1510 may transmit, to the set of UEs, both the first multicast downlink shared channel and the second multicast downlink shared channel in accordance with corresponding multicast downlink shared channel parameters included in the DCI message.

The network communications manager 1515 may manage communications with the core network (e.g., via one or more wired backhaul links). For example, the network communications manager 1515 may manage the transfer of data communications for client devices, such as one or more UEs 115.

The transceiver 1520 may communicate bi-directionally, via one or more antennas, wired, or wireless links as described above. For example, the transceiver 1520 may represent a wireless transceiver and may communicate bi-directionally with another wireless transceiver. The transceiver 1520 may also include a modem to modulate the packets and provide the modulated packets to the antennas for transmission, and to demodulate packets received from the antennas.

In some cases, the wireless device may include a single antenna 1525. However, in some cases the device may have more than one antenna 1525, which may be capable of concurrently transmitting or receiving multiple wireless transmissions.

The memory 1530 may include RAM, ROM, or a combination thereof. The memory 1530 may store computer-readable code 1535 including instructions that, when executed by a processor (e.g., the processor 1540) cause the device to perform various functions described herein. In some cases, the memory 1530 may contain, among other things, a BIOS which may control basic hardware or software operation such as the interaction with peripheral components or devices.

The processor 1540 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some cases, a memory controller may be integrated into processor 1540. The processor 1540 may be configured to execute computer-readable instructions stored in a memory (e.g., the memory 1530) to cause the device 1505 to perform various functions (e.g., functions or tasks supporting multicast grants to UEs of different capabilities using a single DCI).

The inter-station communications manager 1545 may manage communications with other base station 105 and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communication network technology to provide communication between base stations 105.

The code 1535 may include instructions to implement aspects of the present disclosure, including instructions to support wireless communications. The code 1535 may be stored in a non-transitory computer-readable medium such as system memory or other type of memory. In some cases, the code 1535 may not be directly executable by the processor 1540 but may cause a computer (e.g., when compiled and executed) to perform functions described herein.

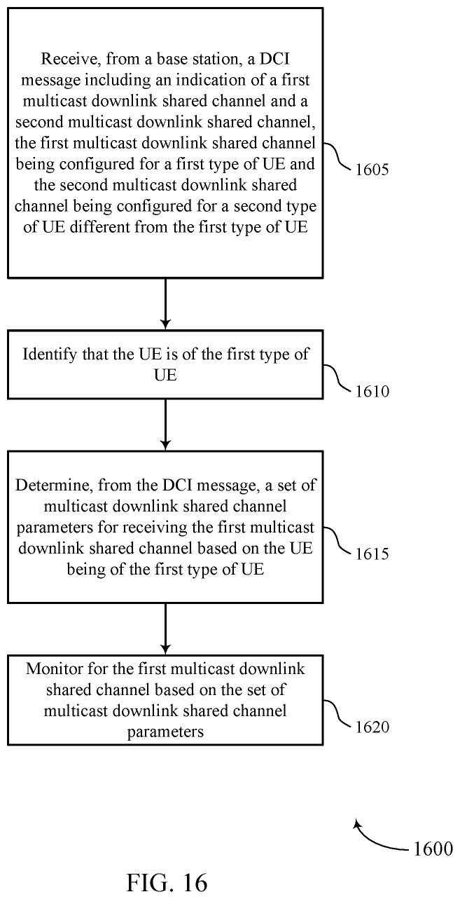

FIG. 16 shows a flowchart illustrating a method 1600 that supports multicast grants to UEs of different capabilities using a single DCI in accordance with aspects of the present disclosure. The operations of method 1600 may be implemented by a UE 115 or its components as described herein. For example, the operations of method 1600 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1605, the UE may receive, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE. The operations of 1605 may be performed according to the methods described herein. In some examples, aspects of the operations of 1605 may be performed by a multicast DCI component as described with reference to FIGS. 8 through 11.

At 1610, the UE may identify that the UE is of the first type of UE. The operations of 1610 may be performed according to the methods described herein. In some examples, aspects of the operations of 1610 may be performed by a type identification component as described with reference to FIGS. 8 through 11.

At 1615, the UE may determine, from the DCI message, a set of multicast downlink shared channel parameters for receiving the first multicast downlink shared channel based on the UE being of the first type of UE. The operations of 1615 may be performed according to the methods described herein. In some examples, aspects of the operations of 1615 may be performed by a multicast PDSCH parameter component as described with reference to FIGS. 8 through 11.

At 1620, the UE may monitor for the first multicast downlink shared channel based on the set of multicast downlink shared channel parameters. The operations of 1620 may be performed according to the methods described herein. In some examples, aspects of the operations of 1620 may be performed by a PDSCH monitoring component as described with reference to FIGS. 8 through 11.

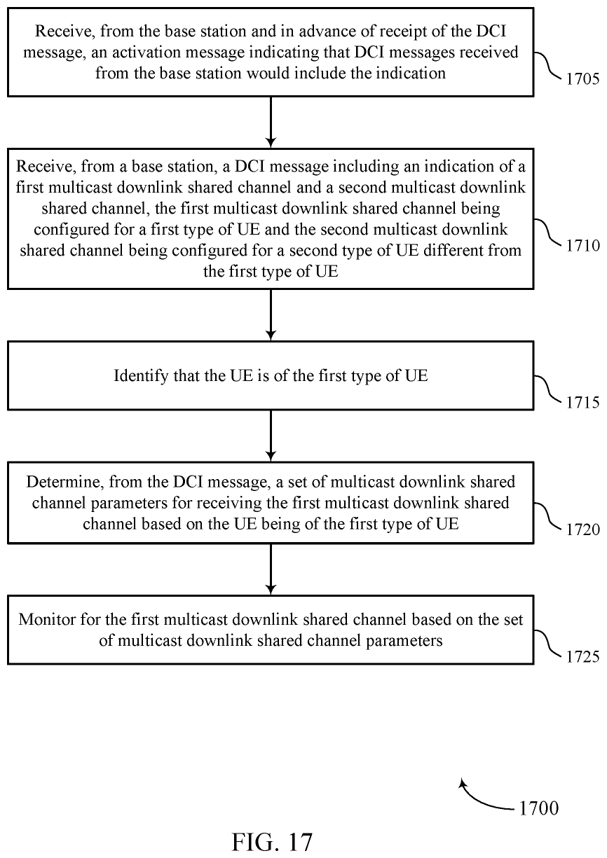

FIG. 17 shows a flowchart illustrating a method 1700 that supports multicast grants to UEs of different capabilities using a single DCI in accordance with aspects of the present disclosure. The operations of method 1700 may be implemented by a UE 115 or its components as described herein. For example, the operations of method 1700 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1705, the UE may receive, from the base station and in advance of receipt of the DCI message, an activation message indicating that DCI messages received from the base station would include the indication. The operations of 1705 may be performed according to the methods described herein. In some examples, aspects of the operations of 1705 may be performed by an activation message component as described with reference to FIGS. 8 through 11.

At 1710, the UE may receive, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE. The operations of 1710 may be performed according to the methods described herein. In some examples, aspects of the operations of 1710 may be performed by a multicast DCI component as described with reference to FIGS. 8 through 11.

At 1715, the UE may identify that the UE is of the first type of UE. The operations of 1715 may be performed according to the methods described herein. In some examples, aspects of the operations of 1715 may be performed by a type identification component as described with reference to FIGS. 8 through 11.

At 1720, the UE may determine, from the DCI message, a set of multicast downlink shared channel parameters for receiving the first multicast downlink shared channel based on the UE being of the first type of UE. The operations of 1720 may be performed according to the methods described herein. In some examples, aspects of the operations of 1720 may be performed by a multicast PDSCH parameter component as described with reference to FIGS. 8 through 11.

At 1725, the UE may monitor for the first multicast downlink shared channel based on the set of multicast downlink shared channel parameters. The operations of 1725 may be performed according to the methods described herein. In some examples, aspects of the operations of 1725 may be performed by a PDSCH monitoring component as described with reference to FIGS. 8 through 11.

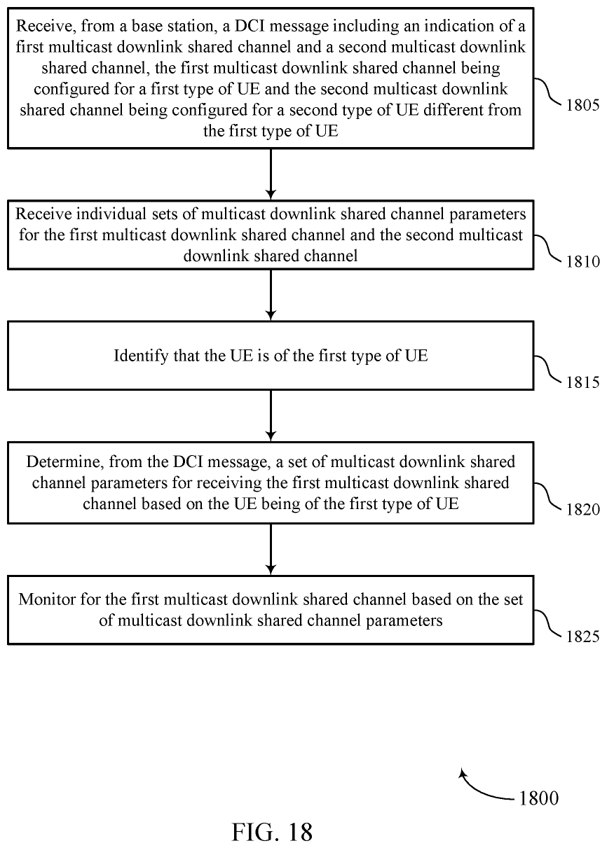

FIG. 18 shows a flowchart illustrating a method 1800 that supports multicast grants to UEs of different capabilities using a single DCI in accordance with aspects of the present disclosure. The operations of method 1800 may be implemented by a UE 115 or its components as described herein. For example, the operations of method 1800 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1805, the UE may receive, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE. The operations of 1805 may be performed according to the methods described herein. In some examples, aspects of the operations of 1805 may be performed by a multicast DCI component as described with reference to FIGS. 8 through 11.

At 1810, the UE may receive individual sets of multicast downlink shared channel parameters for the first multicast downlink shared channel and the second multicast downlink shared channel. The operations of 1810 may be performed according to the methods described herein. In some examples, aspects of the operations of 1810 may be performed by a multicast PDSCH parameter component as described with reference to FIGS. 8 through 11.

At 1815, the UE may identify that the UE is of the first type of UE. The operations of 1815 may be performed according to the methods described herein. In some examples, aspects of the operations of 1815 may be performed by a type identification component as described with reference to FIGS. 8 through 11.

At 1820, the UE may determine, from the DCI message, a set of multicast downlink shared channel parameters for receiving the first multicast downlink shared channel based on the UE being of the first type of UE. The operations of 1820 may be performed according to the methods described herein. In some examples, aspects of the operations of 1820 may be performed by a multicast PDSCH parameter component as described with reference to FIGS. 8 through 11.

At 1825, the UE may monitor for the first multicast downlink shared channel based on the set of multicast downlink shared channel parameters. The operations of 1825 may be performed according to the methods described herein. In some examples, aspects of the operations of 1825 may be performed by a PDSCH monitoring component as described with reference to FIGS. 8 through 11.

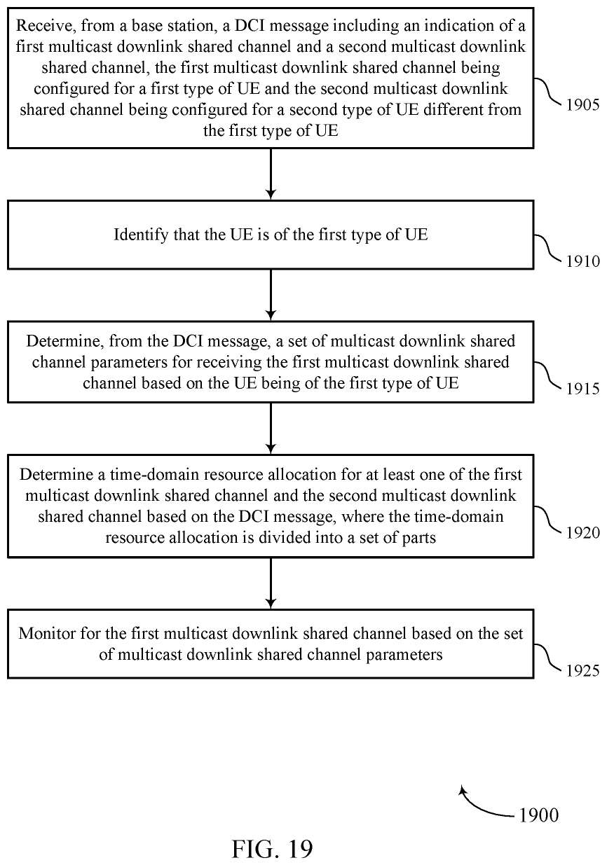

FIG. 19 shows a flowchart illustrating a method 1900 that supports multicast grants to UEs of different capabilities using a single DCI in accordance with aspects of the present disclosure. The operations of method 1900 may be implemented by a UE 115 or its components as described herein. For example, the operations of method 1900 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1905, the UE may receive, from a base station, a DCI message including an indication of a first multicast downlink shared channel and a second multicast downlink shared channel, the first multicast downlink shared channel being configured for a first type of UE and the second multicast downlink shared channel being configured for a second type of UE different from the first type of UE. The operations of 1905 may be performed according to the methods described herein. In some examples, aspects of the operations of 1905 may be performed by a multicast DCI component as described with reference to FIGS. 8 through 11.

At 1910, the UE may identify that the UE is of the first type of UE. The operations of 1910 may be performed according to the methods described herein. In some examples, aspects of the operations of 1910 may be performed by a type identification component as described with reference to FIGS. 8 through 11.

At 1915, the UE may determine, from the DCI message, a set of multicast downlink shared channel parameters for receiving the first multicast downlink shared channel based on the UE being of the first type of UE. The operations of 1915 may be performed according to the methods described herein. In some examples, aspects of the operations of 1915 may be performed by a multicast PDSCH parameter component as described with reference to FIGS. 8 through 11.

At 1920, the UE may determine a time-domain resource allocation for at least one of the first multicast downlink shared channel and the second multicast downlink shared channel based on the DCI message, where the time-domain resource allocation is divided into a set of parts. The operations of 1920 may be performed according to the methods described herein. In some examples, aspects of the operations of 1920 may be performed by a time-domain resource allocation component as described with reference to FIGS. 8 through 11.

At 1925, the UE may monitor for the first multicast downlink shared channel based on the set of multicast downlink shared channel parameters. The operations of 1925 may be performed according to the methods described herein. In some examples, aspects of the operations of 1925 may be performed by a PDSCH monitoring component as described with reference to FIGS. 8 through 11.

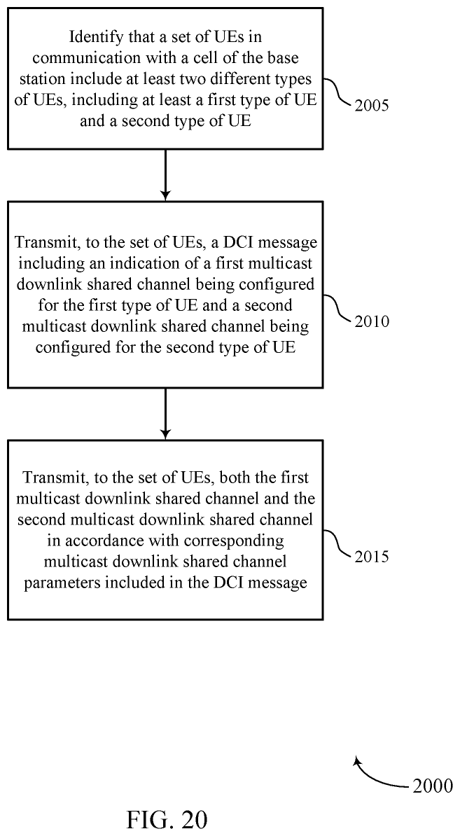

FIG. 20 shows a flowchart illustrating a method 2000 that supports multicast grants to UEs of different capabilities using a single DCI in accordance with aspects of the present disclosure. The operations of method 2000 may be implemented by a base station 105 or its components as described herein. For example, the operations of method 2000 may be performed by a communications manager as described with reference to FIGS. 12 through 15. In some examples, a base station may execute a set of instructions to control the functional elements of the base station to perform the functions described below. Additionally or alternatively, a base station may perform aspects of the functions described below using special-purpose hardware.

At 2005, the base station may identify that a set of UEs in communication with a cell of the base station include at least two different types of UEs, including at least a first type of UE and a second type of UE. The operations of 2005 may be performed according to the methods described herein. In some examples, aspects of the operations of 2005 may be performed by a multicast identification component as described with reference to FIGS. 12 through 15.

At 2010, the base station may transmit, to the set of UEs, a DCI message including an indication of a first multicast downlink shared channel being configured for the first type of UE and a second multicast downlink shared channel being configured for the second type of UE. The operations of 2010 may be performed according to the methods described herein. In some examples, aspects of the operations of 2010 may be performed by a DCI component as described with reference to FIGS. 12 through 15.

At 2015, the base station may transmit, to the set of UEs, both the first multicast downlink shared channel and the second multicast downlink shared channel in accordance with corresponding multicast downlink shared channel parameters included in the DCI message. The operations of 2015 may be performed according to the methods described herein. In some examples, aspects of the operations of 2015 may be performed by a multicast PDSCH component as described with reference to FIGS. 12 through 15.

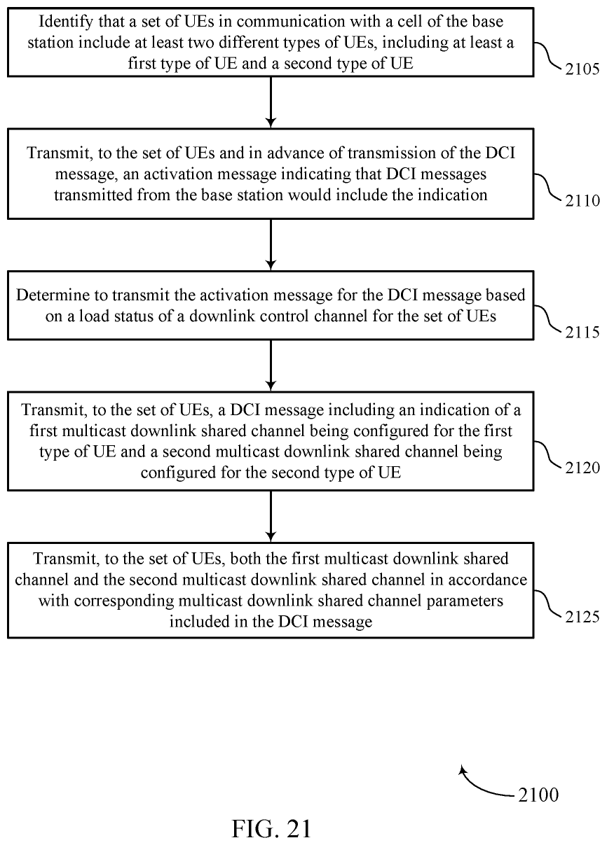

FIG. 21 shows a flowchart illustrating a method 2100 that supports multicast grants to UEs of different capabilities using a single DCI in accordance with aspects of the present disclosure. The operations of method 2100 may be implemented by a base station 105 or its components as described herein. For example, the operations of method 2100 may be performed by a communications manager as described with reference to FIGS. 12 through 15. In some examples, a base station may execute a set of instructions to control the functional elements of the base station to perform the functions described below. Additionally or alternatively, a base station may perform aspects of the functions described below using special-purpose hardware.

At 2105, the base station may identify that a set of UEs in communication with a cell of the base station include at least two different types of UEs, including at least a first type of UE and a second type of UE. The operations of 2105 may be performed according to the methods described herein. In some examples, aspects of the operations of 2105 may be performed by a multicast identification component as described with reference to FIGS. 12 through 15.

At 2110, the base station may transmit, to the set of UEs and in advance of transmission of the DCI message, an activation message indicating that DCI messages transmitted from the base station would include the indication. The operations of 2110 may be performed according to the methods described herein. In some examples, aspects of the operations of 2110 may be performed by a DCI activation message component as described with reference to FIGS. 12 through 15.

At 2115, the base station may determine to transmit the activation message for the DCI message based on a load status of a downlink control channel for the set of UEs. The operations of 2115 may be performed according to the methods described herein. In some examples, aspects of the operations of 2115 may be performed by a DCI activation message component as described with reference to FIGS. 12 through 15.

At 2120, the base station may transmit, to the set of UEs, a DCI message including an indication of a first multicast downlink shared channel being configured for the first type of UE and a second multicast downlink shared channel being configured for the second type of UE. The operations of 2120 may be performed according to the methods described herein. In some examples, aspects of the operations of 2120 may be performed by a DCI component as described with reference to FIGS. 12 through 15.

At 2125, the base station may transmit, to the set of UEs, both the first multicast downlink shared channel and the second multicast downlink shared channel in accordance with corresponding multicast downlink shared channel parameters included in the DCI message. The operations of 2125 may be performed according to the methods described herein. In some examples, aspects of the operations of 2125 may be performed by a multicast PDSCH component as described with reference to FIGS. 12 through 15.

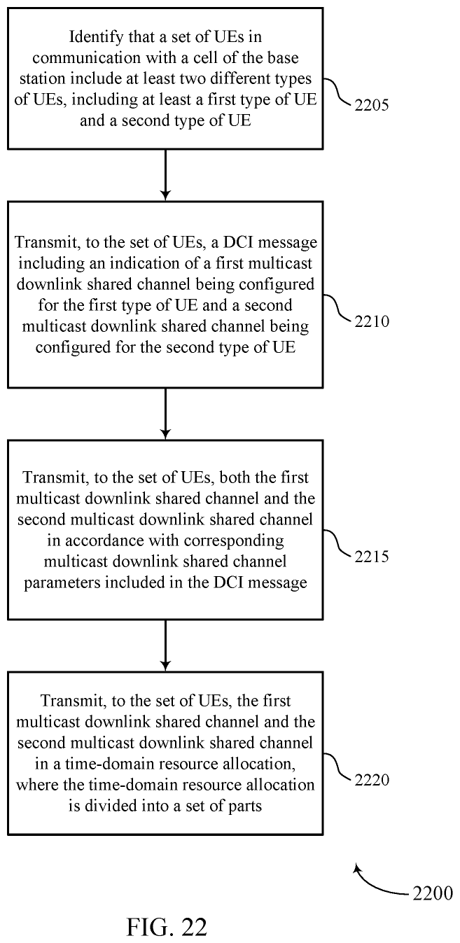

FIG. 22 shows a flowchart illustrating a method 2200 that supports multicast grants to UEs of different capabilities using a single DCI in accordance with aspects of the present disclosure. The operations of method 2200 may be implemented by a base station 105 or its components as described herein. For example, the operations of method 2200 may be performed by a communications manager as described with reference to FIGS. 12 through 15. In some examples, a base station may execute a set of instructions to control the functional elements of the base station to perform the functions described below. Additionally or alternatively, a base station may perform aspects of the functions described below using special-purpose hardware.

At 2205, the base station may identify that a set of UEs in communication with a cell of the base station include at least two different types of UEs, including at least a first type of UE and a second type of UE. The operations of 2205 may be performed according to the methods described herein. In some examples, aspects of the operations of 2205 may be performed by a multicast identification component as described with reference to FIGS. 12 through 15.

At 2210, the base station may transmit, to the set of UEs, a DCI message including an indication of a first multicast downlink shared channel being configured for the first type of UE and a second multicast downlink shared channel being configured for the second type of UE. The operations of 2210 may be performed according to the methods described herein. In some examples, aspects of the operations of 2210 may be performed by a DCI component as described with reference to FIGS. 12 through 15.

At 2215, the base station may transmit, to the set of UEs, both the first multicast downlink shared channel and the second multicast downlink shared channel in accordance with corresponding multicast downlink shared channel parameters included in the DCI message. The operations of 2215 may be performed according to the methods described herein. In some examples, aspects of the operations of 2215 may be performed by a multicast PDSCH component as described with reference to FIGS. 12 through 15.

At 2220, the base station may transmit, to the set of UEs, the first multicast downlink shared channel and the second multicast downlink shared channel in a time-domain resource allocation, where the time-domain resource allocation is divided into a set of parts. The operations of 2220 may be performed according to the methods described herein. In some examples, aspects of the operations of 2220 may be performed by a multicast PDSCH component as described with reference to FIGS. 12 through 15.

It should be noted that the methods described herein describe possible implementations, and that the operations and the steps may be rearranged or otherwise modified and that other implementations are possible. Further, aspects from two or more of the methods may be combined.

The following provides an overview of examples of the present invention:

Example 1: A method for wireless communications at a user equipment (UE), comprising: receiving, from a base station, a downlink control information message comprising an indication of a first multicast downlink shared channel and a second multicast downlink shared channel, the first multicast downlink shared channel being configured for a first type of UE and the second multicast downlink shared channel being configured for a second type of UE different from the first type of UE; identifying that the UE is of the first type of UE; determining, from the downlink control information message, a set of multicast downlink shared channel parameters for receiving the first multicast downlink shared channel based at least in part on the UE being of the first type of UE; and monitoring for the first multicast downlink shared channel based at least in part on the set of multicast downlink shared channel parameters.

Example 2: The method of example 1, further comprising: receiving, from the base station and in advance of receipt of the downlink control information message, an activation message indicating that downlink control information messages received from the base station would include the indication.

Example 3: The method of example 2, wherein receiving the activation message comprises: receiving, from the base station, the activation message via radio resource control signaling or a medium access control (MAC) control element or downlink control information.

Example 4: The method of any one of examples 2 through 3, wherein receiving the activation message comprises: receiving, from the base station, the activation message via downlink control information which is scrambled with a single cell radio network temporary identifier specific to the base station.

Example 5: The method of any one of examples 1 through 4, wherein receiving the downlink control information message comprising the indication comprises: receiving individual sets of multicast downlink shared channel parameters for the first multicast downlink shared channel and the second multicast downlink shared channel.

Example 6: The method of example 5, wherein the individual sets of multicast downlink shared channel parameters comprise a modulation and coding scheme, a time-domain resource assignment, a frequency-domain resource assignment, an antenna ports configuration, or a combination thereof for each of the first multicast downlink shared channel and the second multicast downlink shared channel.

Example 7: The method of any one of examples 5 through 6, wherein one or more parameters of the individual sets of multicast downlink shared channel parameters are the same for the first multicast downlink shared channel and the second multicast downlink shared channel.

Example 8: The method of any one of examples 1 through 7, further comprising: determining a time-domain resource allocation for at least one of the first multicast downlink shared channel and the second multicast downlink shared channel based at least in part on the downlink control information message, wherein the time-domain resource allocation is divided into a plurality of parts.

Example 9: The method of example 8, wherein monitoring for the first multicast downlink shared channel comprises: monitoring for the first multicast downlink shared channel in a first part of the plurality of parts based at least in part on the UE being of the first type, wherein the first type of UE has at least one of the following: more capabilities than the second type of UE, more antennas than the second type of UE, larger or more communication bandwidths than the second type of UE, greater battery capacity than the second type of UE, or greater processing capabilities than the second type of UE.

Example 10: The method of example 8, wherein monitoring for the first multicast downlink shared channel comprises: monitoring for the first multicast downlink shared channel across all parts of the plurality of parts based at least in part on the UE being of the first type, wherein the first type of UE has at least one of the following: fewer capabilities than the second type of UE, fewer antennas than the second type of UE, smaller or fewer communication bandwidths than the second type of UE, lesser battery capacity than the second type of UE, or lesser processing capabilities than the second type of UE.

Example 11: The method of any one of examples 8 through 10, further comprising: receiving, from the base station, a time-domain resource assignment and a frequency-domain resource assignment based at least in part on the UE being of the first type of UE, a number of the plurality of parts, an additional indication of using repetitions or different redundant versions for the first multicast downlink shared channel in each part of the plurality of parts, a redundant version mapping order, or a combination thereof.

Example 12: The method of example 11, wherein each part of the plurality of parts comprises a repetition of the second multicast downlink shared channel.

Example 13: The method of example 11, wherein each part of the plurality of parts comprises a different redundant version of the second multicast downlink shared channel.

Example 14: The method of any one of examples 8 through 13, wherein the plurality of parts is located within a single scheduling time-domain unit, or each part is located in a separate scheduling time-domain unit.

Example 15: The method of example 14, wherein a scheduling time-domain unit comprises a slot, a mini-slot, or a combination thereof.

Example 16: The method of any one of examples 1 through 15, wherein the first type of UE and the second type of UE have different capabilities, different numbers of antennas, different communication bandwidths, different battery capacities, different processing capabilities, or a combination thereof.

Example 17: A method for wireless communications at a base station, comprising: identifying that a plurality of user equipment (UEs) in communication with a cell of the base station include at least two different types of UEs, including at least a first type of UE and a second type of UE; transmitting, to the plurality of UEs, a downlink control information message comprising an indication of a first multicast downlink shared channel being configured for the first type of UE and a second multicast downlink shared channel being configured for the second type of UE; and transmitting, to the plurality of UEs, both the first multicast downlink shared channel and the second multicast downlink shared channel in accordance with corresponding multicast downlink shared channel parameters included in the downlink control information message.

Example 18: The method of example 17, further comprising: transmitting, to the plurality of UEs and in advance of transmission of the downlink control information message, an activation message indicating that downlink control information messages transmitted from the base station would include the indication.

Example 19: The method of example 18, wherein transmitting the activation message comprises: transmitting, to the plurality of UEs, the activation message via radio resource control signaling or a medium access control (MAC) control element or downlink control information.

Example 20: The method of any one of examples 18 through 19, wherein transmitting the activation message comprises: transmitting, to the plurality of UEs, the activation message via downlink control information which is scrambled with a single cell radio network temporary identifier specific to the base station.

Example 21: The method of any one of examples 18 through 20, further comprising: determining to transmit the activation message for the downlink control information message based at least in part on a load status of a downlink control channel for the plurality of UEs.

Example 22: The method of any one of examples 17 through 21, wherein transmitting the downlink control information message comprising the indication comprises: transmitting individual sets of multicast downlink shared channel parameters for each of the first multicast downlink shared channel and the second multicast downlink shared channel.

Example 23: The method of example 22, wherein the individual sets of multicast downlink shared channel parameters comprise a modulation and coding scheme, a time-domain resource assignment, a frequency-domain resource assignment, an antenna ports configuration, or a combination thereof for each of the first multicast downlink shared channel and the second multicast downlink shared channel.

Example 24: The method of any one of examples 22 through 23, wherein one or more parameters of the individual sets of multicast downlink shared channel parameters are the same or are related values for each of the first multicast downlink shared channel and the second multicast downlink shared channel.

Example 25: The method of any one of examples 17 through 24, wherein transmitting the first multicast downlink shared channel and the second multicast downlink shared channel comprises: transmitting, to the plurality of UEs, the first multicast downlink shared channel and the second multicast downlink shared channel in a time-domain resource allocation, wherein the time-domain resource allocation is divided into a plurality of parts.

Example 26: The method of example 25, further comprising: transmitting the first multicast downlink shared channel in a first part of the plurality of parts, wherein the first multicast downlink shared channel is transmitted for the first type of UE; and transmitting the second multicast downlink shared channel across all parts of the plurality of parts, wherein the second downlink shared channel is transmitted for the second type of UE, wherein the first type of UE has at least one of the following: more capabilities than the second type of UE, more antennas than the second type of UE, larger or more communication bandwidths than the second type of UE, greater battery capacity than the second type of UE, or greater processing capabilities than the second type of UE.

Example 27: The method of example 26, wherein each part of the plurality of parts comprises a repetition of the second multicast downlink shared channel.

Example 28: The method of example 26, wherein each part of the plurality of parts comprises a different redundant version of the second multicast downlink shared channel.

Example 29: The method of any one of examples 25 through 28, further comprising: transmitting, to the plurality of UEs, a time-domain resource assignment and a frequency-domain resource assignment for the first multicast downlink shared channel and the second multicast downlink shared channel based at least in part on a type of UE, a number of the plurality of parts, an additional indication of using repetitions or different redundant versions for the multicast downlink shared channel in each part of the plurality of parts, a redundant version mapping order, or a combination thereof.

Example 30: The method of any one of examples 25 through 29, wherein the plurality of parts is located within a single scheduling time-domain unit, or each part is located in a separate scheduling time-domain unit.

Example 31: The method of example 30, a scheduling time-domain unit comprises a slot, a mini-slot, or a combination thereof.

Example 32: The method of any one of examples 17 through 31, wherein the first type of UE and the second type of UE have different capabilities, different numbers of antennas, different communication bandwidths, different battery capacities, different processing capabilities, or a combination thereof.

Example 33: An apparatus for wireless communications at a user equipment (UE) comprising at least one means for performing a method of any one of examples 1 through 16.

Example 34: An apparatus for wireless communications at a user equipment (UE) comprising a processor and memory coupled to the processor, the processor and memory configured to perform a method of any one of examples 1 through 16.

Example 35: A non-transitory computer-readable medium storing code for wireless communications at a user equipment (UE), the code comprising instructions executable by a processor to perform a method of any one of examples 1 through 16.

Example 36: An apparatus for wireless communications at a base station comprising at least one means for performing a method of any one of examples 17 through 32.

Example 37: An apparatus for wireless communications at a base station comprising a processor and memory coupled to the processor, the processor and memory configured to perform a method of any one of examples 17 through 32.

Example 38: A non-transitory computer-readable medium storing code for wireless communications at a base station, the code comprising instructions executable by a processor to perform a method of any one of examples 17 through 32.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a user equipment (UE), comprising:
receiving, from a base station, a downlink control information message comprising an indication of a first multicast downlink shared channel and a second multicast downlink shared channel, the first multicast downlink shared channel being configured for a first type of UE and the second multicast downlink shared channel being configured for a second type of UE different from the first type of UE;
identifying that the UE is of the first type of UE;
determining, from the downlink control information message, a set of multicast downlink shared channel parameters for receiving the first multicast downlink shared channel based at least in part on the UE being of the first type of UE; and
monitoring for the first multicast downlink shared channel based at least in part on the set of multicast downlink shared channel parameters.

2-16. (canceled)

17. A method for wireless communications at a base station, comprising:
identifying that a plurality of user equipment (UEs) in communication with a cell of the base station include at least two different types of UEs, including at least a first type of UE and a second type of UE;
transmitting, to the plurality of UEs, a downlink control information message comprising an indication of a first multicast downlink shared channel being configured for the first type of UE and a second multicast downlink shared channel being configured for the second type of UE; and
transmitting, to the plurality of UEs, both the first multicast downlink shared channel and the second multicast downlink shared channel in accordance with corresponding multicast downlink shared channel parameters included in the downlink control information message.

18-32. (canceled)

33. An apparatus for wireless communications at a user equipment (UE), comprising:
a processor,
memory coupled with the processor; and
instructions stored in the memory and executable by the processor to cause the apparatus to:
receive, from a base station, a downlink control information message comprising an indication of a first multicast downlink shared channel and a second multicast downlink shared channel, the first multicast downlink shared channel being configured for a first type of UE and the second multicast downlink shared channel being configured for a second type of UE different from the first type of UE;
identify that the UE is of the first type of UE;
determine, from the downlink control information message, a set of multicast downlink shared channel parameters for receiving the first multicast downlink shared channel based at least in part on the UE being of the first type of UE; and
monitor for the first multicast downlink shared channel based at least in part on the set of multicast downlink shared channel parameters.

34. The apparatus of claim 33, wherein the instructions are further executable by the processor to cause the apparatus to:
receive, from the base station and in advance of receipt of the downlink control information message, an activation message indicating that downlink control information messages received from the base station would include the indication.

35. The apparatus of claim 34, wherein the instructions to receive the activation message are executable by the processor to cause the apparatus to:
receive, from the base station, the activation message via radio resource control signaling or a medium access control (MAC) control element or downlink control information.

36. The apparatus of claim 34, wherein the instructions to receive the activation message are executable by the processor to cause the apparatus to:
receive, from the base station, the activation message via downlink control information which is scrambled with a single cell radio network temporary identifier specific to the base station.

37. The apparatus of claim 33, wherein the instructions are further executable by the processor to cause the apparatus to:
receive individual sets of multicast downlink shared channel parameters for the first multicast downlink shared channel and the second multicast downlink shared channel.

38. The apparatus of claim 37, wherein the individual sets of multicast downlink shared channel parameters comprise a modulation and coding scheme, a time-domain resource assignment, a frequency-domain resource assignment, an antenna ports configuration, or a combination thereof for each of the first multicast downlink shared channel and the second multicast downlink shared channel.

39. The apparatus of claim 37, wherein one or more parameters of the individual sets of multicast downlink shared channel parameters are the same for the first multicast downlink shared channel and the second multicast downlink shared channel.

40. The apparatus of claim 33, wherein the instructions are further executable by the processor to cause the apparatus to:
determine a time-domain resource allocation for at least one of the first multicast downlink shared channel and the second multicast downlink shared channel based at least in part on the downlink control information message, wherein the time-domain resource allocation is divided into a plurality of parts.

41. The apparatus of claim 40, wherein the instructions to monitor for the first multicast downlink shared channel are executable by the processor to cause the apparatus to:
monitor for the first multicast downlink shared channel in a first part of the plurality of parts based at least in part on the UE being of the first type, wherein the first type of UE has at least one of the following: more capabilities than the second type of UE, more antennas than the second type of UE, larger or more communication bandwidths than the second type of UE, greater battery capacity than the second type of UE, or greater processing capabilities than the second type of UE.

42. The apparatus of claim 40, wherein the instructions to monitor for the first multicast downlink shared channel are executable by the processor to cause the apparatus to:
monitor for the first multicast downlink shared channel across all parts of the plurality of parts based at least in part on the UE being of the first type, wherein the first type of UE has at least one of the following: fewer capabilities than the second type of UE, fewer antennas than the second type of UE, smaller or fewer communication bandwidths than the second type of UE, lesser battery capacity than the second type of UE, or lesser processing capabilities than the second type of UE.

43. The apparatus of claim 40, wherein the instructions are further executable by the processor to cause the apparatus to:
receive, from the base station, a time-domain resource assignment and a frequency-domain resource assignment based at least in part on the UE being of the first type of UE, a number of the plurality of parts, an additional indication of using repetitions or different redundant versions for the first multicast downlink shared channel in each part of the plurality of parts, a redundant version mapping order, or a combination thereof.

44. The apparatus of claim 43, wherein each part of the plurality of parts comprises a repetition of the second multicast downlink shared channel.

45. The apparatus of claim 43, wherein each part of the plurality of parts comprises a different redundant version of the second multicast downlink shared channel.

46. The apparatus of claim 40, wherein the plurality of parts is located within a single scheduling time-domain unit, or each part is located in a separate scheduling time-domain unit.

47. The apparatus of claim 46, wherein a scheduling time-domain unit comprises a slot, a mini-slot, or a combination thereof.

48. The apparatus of claim 33, wherein the first type of UE and the second type of UE have different capabilities, different numbers of antennas, different communication bandwidths, different battery capacities, different processing capabilities, or a combination thereof.

49. An apparatus for wireless communications at a base station, comprising:
a processor,
memory coupled with the processor; and
instructions stored in the memory and executable by the processor to cause the apparatus to:
identify that a plurality of user equipment (UEs) in communication with a cell of the base station include at least two different types of UEs, including at least a first type of UE and a second type of UE;
transmit, to the plurality of UEs, a downlink control information message comprising an indication of a first multicast downlink shared channel being configured for the first type of UE and a second multicast downlink shared channel being configured for the second type of UE; and
transmit, to the plurality of UEs, both the first multicast downlink shared channel and the second multicast downlink shared channel in accordance with corresponding multicast downlink shared channel parameters included in the downlink control information message.

50. The apparatus of claim 49, wherein the instructions are further executable by the processor to cause the apparatus to:
transmit, to the plurality of UEs and in advance of transmission of the downlink control information message, an activation message indicating that downlink control information messages transmitted from the base station would include the indication.

51. The apparatus of claim 50, wherein the instructions to transmit the activation message are executable by the processor to cause the apparatus to:
transmit, to the plurality of UEs, the activation message via radio resource control signaling or a medium access control (MAC) control element or downlink control information.

52. The apparatus of claim 50, wherein the instructions to transmit the activation message are executable by the processor to cause the apparatus to:
transmit, to the plurality of UEs, the activation message via downlink control information which is scrambled with a single cell radio network temporary identifier specific to the base station.

53. The apparatus of claim 50, wherein the instructions are further executable by the processor to cause the apparatus to:
determine to transmit the activation message for the downlink control information message based at least in part on a load status of a downlink control channel for the plurality of UEs.

54. The apparatus of claim 49, wherein transmitting the downlink control information message comprising the indication comprises, and the instructions are further executable by the processor to cause the apparatus to:
transmit individual sets of multicast downlink shared channel parameters for each of the first multicast downlink shared channel and the second multicast downlink shared channel.

55. The apparatus of claim 54, wherein the individual sets of multicast downlink shared channel parameters comprise a modulation and coding scheme, a time-domain resource assignment, a frequency-domain resource assignment, an antenna ports configuration, or a combination thereof for each of the first multicast downlink shared channel and the second multicast downlink shared channel.

56. The apparatus of claim 54, wherein one or more parameters of the individual sets of multicast downlink shared channel parameters are the same or are related values for each of the first multicast downlink shared channel and the second multicast downlink shared channel.

57. The apparatus of claim 49, wherein the instructions to transmit the first multicast downlink shared channel and the second multicast downlink shared channel are executable by the processor to cause the apparatus to:
transmit, to the plurality of UEs, the first multicast downlink shared channel and the second multicast downlink shared channel in a time-domain resource allocation, wherein the time-domain resource allocation is divided into a plurality of parts.

58. The apparatus of claim 57, wherein the instructions are further executable by the processor to cause the apparatus to:
transmit the first multicast downlink shared channel in a first part of the plurality of parts, wherein the first multicast downlink shared channel is transmitted for the first type of UE; and
transmit the second multicast downlink shared channel across all parts of the plurality of parts, wherein the second multicast downlink shared channel is transmitted for the second type of UE, wherein the first type of UE has at least one of the following: more capabilities than the second type of UE, more antennas than the second type of UE, larger or more communication bandwidths than the second type of UE, greater battery capacity than the second type of UE, or greater processing capabilities than the second type of UE.

59. The apparatus of claim 58, wherein each part of the plurality of parts comprises a repetition of the second multicast downlink shared channel.

60. The apparatus of claim 58, wherein each part of the plurality of parts comprises a different redundant version of the second multicast downlink shared channel.

61. The apparatus of claim 57, wherein the instructions are further executable by the processor to cause the apparatus to:
transmit, to the plurality of UEs, a time-domain resource assignment and a frequency-domain resource assignment for the first multicast downlink shared channel and the second multicast downlink shared channel based at least in part on a type of UE, a number of the plurality of parts, an additional indication of using repetitions or different redundant versions for the first multicast downlink shared channel in each part of the plurality of parts, a redundant version mapping order, or a combination thereof.

62. The apparatus of claim 57, wherein the plurality of parts is located within a single scheduling time-domain unit, or each part is located in a separate scheduling time-domain unit.

63. The apparatus of claim 62, wherein a scheduling time-domain unit comprises a slot, a mini-slot, or a combination thereof.

64. The apparatus of claim 49, wherein the first type of UE and the second type of UE have different capabilities, different numbers of antennas, different communication bandwidths, different battery capacities, different processing capabilities, or a combination thereof.

65. An apparatus for wireless communications at a user equipment (UE), comprising:
means for receiving, from a base station, a downlink control information message comprising an indication of a first multicast downlink shared channel and a second multicast downlink shared channel, the first multicast downlink shared channel being configured for a first type of UE and the second multicast downlink shared channel being configured for a second type of UE different from the first type of UE;
means for identifying that the UE is of the first type of UE;
means for determining, from the downlink control information message, a set of multicast downlink shared channel parameters for receiving the first multicast downlink shared channel based at least in part on the UE being of the first type of UE; and
means for monitoring for the first multicast downlink shared channel based at least in part on the set of multicast downlink shared channel parameters.

66-98. (canceled)
